(19) United States
(12) Patent Application Publication
(10) Pub. No.: US 2022/0214894 A1
(43) Pub. Date: Jul. 7, 2022

(54) COMMAND EXECUTION METHOD, APPARATUS, AND DEVICE

(71) Applicant: HUAWEI TECHNOLOGIES CO., LTD., Shenzhen (CN)

(72) Inventors: Tao CAI, Hong Kong (CN); Lifeng SHANG, Hong Kong (CN); Xiaoguang LI, Shenzhen (CN); Yuyang ZHANG, Shenzhen (CN); Wei ZHANG, Shenzhen (CN); Li QIAN, Shenzhen (CN)

(73) Assignee: HUAWEI TECHNOLOGIES CO., LTD., Shenzhen (CN)

(21) Appl. No.: 17/701,339

(22) Filed: Mar. 22, 2022

Related U.S. Application Data
(63) Continuation of application No. PCT/CN2020/112832, filed on Sep. 1, 2020.

(30) Foreign Application Priority Data
Sep. 27, 2019 (CN) 201910937857.9

(51) Int. Cl. G06F 9/451; G06F 3/0481; G06F 3/0487

(52) U.S. Cl. CPC G06F 9/451; G06F 3/0487; G06F 3/0481

(57) ABSTRACT

Embodiments of the present disclosure disclose a command execution method and apparatus, a terminal, and a server related speech recognition and natural language processing. In the command execution method, during an interaction between a terminal and a user, a server configured to execute a user command or the terminal may store slots and GUI information corresponding to the slots. When the filling information of the slots configured for the user command is missing, the server configured to execute the user command may obtain the missing filling information of the slots from the stored GUI information, to avoid multiple interactions between the user and the terminal. The interaction between the user and the terminal is made more intelligent, thus improving command execution efficiency.

### CROSS-REFERENCE TO RELATED APPLICATIONS

This application is a continuation of International Application No. PCT/CN2020/112832, filed on Sep. 1, 2020, which claims priority to Chinese Patent Application No. 201910937857.9, filed on Sep. 27, 2019. The disclosures of the aforementioned applications are hereby incorporated by reference in their entireties.

### TECHNICAL FIELD

This application relates to the field of computer technologies, and in particular, to a command execution method, apparatus, and device.

### BACKGROUND

Human-computer dialogs have been widely applied to people's daily life, such as a chatbot, a customer service robot, a smart speaker, and a voice assistant. Implementation of dialogs between machines and humans mainly includes three steps: (1) understanding, that is, using a speech recognition technology to convert a user command (such as a voice command) entered by a user into text; (2) comprehending, that is, performing intent identification on the text obtained through conversion, to comprehend the intent of the user command; and (3) replying, that is, generating response information based on the intent of the user command. Usually, a machine cannot accurately generate a reply when the user intent identified based on the user command entered by the user lacks key information.

For example, when the user command is “How far is this hotel from Hongqiao Airport?”, in response to the user command, the machine needs to know which hotel “this hotel” refers to. In a conventional technology, the machine asks the user “From which hotel its distance to Hongqiao Airport do you want to query?”, and the terminal receives information entered by the user, for example, “Hilton Hotel”, which is the filling information of the slot. It can be learned that the machine needs to interact with the user for a plurality of times to obtain the missing slot filling information in the user command in order to execute the user command. Consequently, it takes a long time to respond to the user command.

### SUMMARY

The technical problem to be solved in the embodiments of the present disclosure lies in providing a command execution method, to avoid a plurality of interactions between a terminal and a user caused by the lack of slot filling information.

According to a first aspect, an embodiment of the present disclosure provides a command execution method, including: A terminal generates a first request based on an input user command, where the first request is used to request a server to execute the user command; further, the terminal sends the first request to the server, and receives a second request sent by the server, where the second request is used to request first information from the terminal, and the first information is used to determine filling information of a first slot, where the first slot is a slot that lacks filling information among the M slots configured for the target intent of the user command, M is a positive integer, and the target intent and filling information of the M slots are used by the server to execute the user command; further, the terminal determines the first information in a first GUI information set based on the second request, where the first GUI information set includes a correspondence between slots and GUI information; and further, the terminal sends the first information to the server, so that the server executes the user command based on the target intent and the filling information of the M slots.

Optionally, the terminal may alternatively receive and output response information of the user command from the server.

When the foregoing method is performed, when the filling information of a slot is missing and is required for executing the target intent, the missing filling information is obtained from the first GUI information set, to avoid interactions between the user and the terminal to provide the filling information. This is more intelligent and improves the efficiency of executing the user command.

With reference to the first aspect, in a possible implementation, the method further includes: The terminal updates or stores graphical user interface (GUI) information corresponding to a first control when detecting a user operation for the first control on a GUI, where the GUI is a user interface displayed on the terminal.

With reference to the first aspect, in a possible implementation, the first information may be the filling information of the first slot or the GUI information corresponding to the first slot.

When the first information is the filling information of the first slot, when the filling information of the first slot is missing, the server requests the missing filling information of the slot from the terminal, and the terminal obtains the filling information of the first slot from the stored first GUI information set, to avoid interactions between the user and the terminal to provide the filling information. This is more intelligent and improves the efficiency of executing the user command.

When the first information is the filling information of the first slot, when the filling information of the first slot is missing, the server requests the GUI information corresponding to the missing filling information of the slot from the terminal, and the terminal obtains the requested GUI information from the stored first GUI information set. Further, the server may determine the missing filling information of the slot based on the GUI information, to prevent the processing process of determining the filling information of the slot from the first GUI information set from being performed in the terminal with limited processing resources. The foregoing method is performed by using the server, and may further improve the efficiency of executing the command.

With reference to the first aspect, in a possible implementation, an implementation in which the terminal generates the first request based on the input user command may be: The terminal identifies a predicted intent of the input user command; obtains GUI information corresponding to a second slot from the first GUI information set when the filling information of the second slot is missing, where the second slot is a slot that lacks filling information among the N slots configured for the predicted intent of the user command, and N is a positive integer; and further generates the first request based on the user command and the GUI information corresponding to the second slot, where the first request carries the GUI information corresponding to the second slot, so that after receiving the first request, the server determines the first slot based on the user command and the GUI information corresponding to the second slot.

When the foregoing method is performed, the terminal may include an intent classifier of a coarse granularity, to predict the predicted intent of the user command, and the terminal sends the possibly missing filling information of the second slot and the user command to the server together, so that the server can identify the target intent more accurately. The filling information of the M slots configured for the target intent may be obtained from the user command and the filling information of the second slot at a high probability, to further reduce interactions between the business server and the terminal to provide the filling information of the slot.

With reference to the first aspect, in a possible implementation, another implementation in which the terminal generates the first request based on the input user command may be: The terminal generates the first request based on the input user command and a second GUI information set, where the first request carries the second GUI information set, so that after receiving the first request, the server determines the first slot based on the user command and the second GUI information set.

When the foregoing method is performed, the terminal sends the second GUI information set and the user command to the server together, so that the filling information of the M slots configured for the target intent of the user command identified by the server can be obtained from the user command and the second GUI information set at a high probability, to further reduce interactions between the business server and the terminal to provide the filling information of the slot.

According to a second aspect, an embodiment of this disclosure provides a command execution method. The method includes: A server receives a first request sent by a terminal, where the first request is used to request the server to execute a user command; determines filling information of a first slot from a first GUI information set when the filling information of the first slot is missing, where the first slot is a slot that lacks filling information among the M slots configured for a target intent of the user command, M is a positive integer, and the first GUI information set includes a correspondence between slots and GUI information; and further executes the user command based on the target intent of the user command and the filling information of the slots configured for the target intent, to obtain response information of the user command; and further sends the response information to the terminal.

When the foregoing method is performed, when the filling information of a slot is missing, the server obtains the missing filling information from the first GUI information set, to avoid interactions between the user and the terminal to provide the filling information. This is more intelligent and improves the efficiency of executing the user command.

With reference to the second aspect, in a possible implementation, the first GUI information set includes GUI information corresponding to a first control, the GUI information corresponding to the first control is stored or updated by the terminal when the terminal detects a user operation for the first control on a graphical user interface (GUI), where the GUI is a user interface displayed on the terminal.

With reference to the second aspect, in a possible implementation, an implementation in which the server determines the filling information of the first slot from the first GUI information set when the filling information of the first slot is missing may be: The server sends a second request to the terminal when the filling information of the first slot is missing, where the second request is used to request the filling information of the first slot from the terminal; and further receives the filling information of the first slot from the terminal, where the filling information of the first slot is determined by the terminal from the first GUI information set.

When the foregoing method is performed, when the filling information of the first slot is missing, the server requests the missing filling information of the slot from the terminal, and the terminal obtains the filling information of the first slot from the stored first GUI information set, to avoid interactions between the user and the terminal to provide the filling information. This is more intelligent and improves the efficiency of executing the user command.

With reference to the second aspect, in a possible implementation, another implementation in which the server determines the filling information of the first slot from the first GUI information set when the filling information of the first slot is missing may be: The server sends a third request to the terminal when the filling information of the first slot is missing, where the third request is used to request GUI information corresponding to the first slot from the terminal; and further receives the GUI information corresponding to the first slot from the terminal, and determines the filling information of the first slot based on the GUI information corresponding to the first slot, where the filling information of the first slot is determined by the terminal from the first GUI information set.

When the foregoing method is performed, when the filling information of the first slot is missing, the server requests the GUI information corresponding to the missing filling information of the slot from the terminal, and the terminal obtains the requested GUI information from the stored first GUI information set. Further, the server may determine the missing filling information of the slot based on the GUI information, to prevent a processing process of determining the filling information of the slot from the first GUI information set from being performed in the terminal with limited processing resources. The foregoing method is performed by using the server, and may further improve the efficiency of executing the command.

With reference to the second aspect, in a possible implementation, the first request carries GUI information corresponding to a second slot, and after the server receives the first request sent by the terminal, and before the server determines the filling information of the first slot from the first GUI information set when the filling information of the first slot is missing, the method may further include: The server determines the first slot based on the user command and the GUI information corresponding to the second slot, where the second slot is a slot that lacks filling information among the N slots configured for a predicted intent of the user command, N is a positive integer, and the predicted intent is an intent of the user command that is identified by the terminal.

When the foregoing method is performed, the terminal may include an intent classifier of a coarse granularity, to predict the predicted intent of the user command, and the terminal sends the possibly missing filling information of the second slot and the user command to the server together, so that the server can identify the target intent more accurately. The filling information of the M slots configured for the target intent may be obtained from the user command and the filling information of the second slot at a high probability, to further reduce interactions between the business server and the terminal to provide the filling information of the slot.

With reference to the second aspect, in a possible implementation, the first request carries a second GUI information set, and after the server receives the first request sent by the terminal, and before the server determines the filling information of the first slot from the first GUI information set when the filling information of the first slot is missing, the method may further include: The server determines the first slot based on the user command and the second GUI information set.

When the foregoing method is performed, the terminal sends the second GUI information set and the user command to the server together, so that the filling information of the M slots configured for the target intent of the user command identified by the server can be obtained from the user command and the second GUI information set at a high probability, to further reduce interactions between the business server and the terminal to provide the filling information of the slot.

With reference to the second aspect, in a possible implementation, the first request carries the first GUI information set.

When the foregoing method is performed, the terminal also sends the first GUI information set to the server when sending the request to the server. In this case, the server does not need to request the missing filling information from the terminal, and may directly determine the filling information of the first slot from the first GUI information set, to further reduce interactions between the business server and the terminal to provide the filling information of the slot.

With reference to the second aspect, in a possible implementation, the method further includes: The server may further receive the GUI information that corresponds to the first control and that is sent by the terminal, and update or store the GUI information corresponding to the first control, where the first control is a control on the graphical user interface (GUI) of the terminal.

Optionally, the GUI information corresponding to the first control is the GUI information that corresponds to the first control on the graphical user interface (GUI) and that is obtained by the terminal when the terminal detects a user operation for the first control, where the GUI is a user interface displayed on the terminal.

When the foregoing method is performed, the GUI information generated by the user operation can be updated to the server in real time. To be specific, the server stores the first GUI information set. In this case, the server does not need to request the missing filling information from the terminal, and may directly determine the filling information of the first slot from the first GUI information set, to further reduce interactions between the business server and the terminal to provide the filling information of the slot.

According to a third aspect, an embodiment of this disclosure further provides a command execution method. The method includes: A terminal identifies a target intent of an input user command after the user command is received; obtains filling information of a first slot from a first GUI information set when the filling information of the first slot is missing, where the first slot is a slot that lacks filling information among the M slots configured for the target intent, M is a positive integer, and the first GUI information set includes a correspondence between slots and GUI information; and further, the terminal executes the user command based on the target intent and filling information of the M slots, to obtain response information of the user command, and outputs the response information.

Optionally, an implementation in which the terminal executes the user command based on the target intent and the filling information of the M slots, to obtain the response information of the user command may be: The terminal generates a fourth request based on the target intent and the filling information of the M slots; and further sends the fourth request to a server, so that the server executes the target intent based on the target intent and the filling information of the M slots after receiving the fourth request, and obtains the response information and sends the response information to the terminal, and further, the terminal receives the response information.

According to a fourth aspect, an embodiment of this disclosure further provides a command execution method. The method includes: A server receives a fourth request sent by a terminal, where the fourth request is used to request to execute a target intent of a user command, the fourth request carries the target intent and filling information of M slots configured for the target intent, the filling information of the M slots includes filling information of a first slot, the filling information of the first slot is determined by the terminal based on a first GUI information set, M is a positive integer, and the first GUI information set includes a correspondence between slots and GUI information; and further, the server executes the target intent based on the target intent and the filling information of the M slots, to obtain response information, and sends the response information to the terminal.

According to a fifth aspect, an embodiment of this disclosure further provides a command execution apparatus, used in a terminal. The apparatus can implement the command execution method according to any implementation of the first aspect.

According to a sixth aspect, an embodiment of this disclosure further provides a terminal. The terminal includes one or more processors, one or more memories, and a communication interface, where the communication interface is configured to perform data exchange with a server, the one or more memories are coupled to the one or more processors, the one or more memories are configured to store computer program code, the computer program code includes computer instructions, and when the one or more processors execute the computer instructions, the terminal performs the command execution method according to any implementation of the first aspect.

According to a seventh aspect, an embodiment of this disclosure further provides a command execution apparatus, used in a server. The apparatus can implement the command execution method according to any implementation of the second aspect.

According to an eighth aspect, an embodiment of this disclosure further provides a server. The server includes one or more processors, one or more memories, and a communication interface, where the communication interface is configured to perform data exchange with a terminal, the one or more memories are coupled to the one or more processors, the one or more memories are configured to store computer program code, the computer program code includes computer instructions, and when the one or more processors execute the computer instructions, the terminal performs the command execution method according to any implementation of the second aspect.

According to a ninth aspect, an embodiment of this disclosure further provides a command execution apparatus, used in a terminal. The apparatus can implement the command execution method according to any implementation of the second aspect.

According to a tenth aspect, an embodiment of this disclosure further provides a terminal. The terminal includes one or more processors, one or more memories, and a communication interface, where the communication interface is configured to perform data exchange with a server, the one or more memories are coupled to the one or more processors, the one or more memories are configured to store computer program code, the computer program code includes computer instructions, and when the one or more processors execute the computer instructions, the terminal performs the command execution method according to any implementation of the third aspect.

According to an eleventh aspect, an embodiment of this disclosure further provides a command execution apparatus, used in a server. The apparatus can implement the command execution method according to any implementation of the fourth aspect.

According to a twelfth aspect, an embodiment of this disclosure further provides a server. The server includes one or more processors, one or more memories, and a communication interface, where the communication interface is configured to perform data exchange with a terminal, the one or more memories are coupled to the one or more processors, the one or more memories are configured to store computer program code, the computer program code includes computer instructions, and when the one or more processors execute the computer instructions, the terminal performs the command execution method according to any implementation of the fourth aspect.

According to a thirteenth aspect, an embodiment of this disclosure further provides a terminal, where the terminal includes a touchscreen, one or more memories, and one or more processors configured to execute one or more programs stored in the memory, the terminal displays a user graphical interface (GUI) by using the display screen, and the GUI includes a first control, where the terminal stores or updates GUI information corresponding to the first control when detecting a user operation for the first control.

According to a fourteenth aspect, an embodiment of this disclosure further provides a graphical user interface (GUI), where the GUI is displayed on a terminal, the terminal includes a touchscreen, one or more memories, and one or more processors configured to execute one or more programs stored in the memory, the terminal displays the user graphical interface (GUI) by using the display screen, and the GUI includes a first control, where the terminal stores or updates GUI information corresponding to the first control when detecting a user operation for the first control.

With reference to the thirteenth aspect or the fourteenth aspect, in a possible implementation, the GUI further includes a text input control, where in response to a detected user instruction in a text format input for the text input control, the user instruction in the text format is sent to a server.

With reference to the thirteenth aspect or the fourteenth aspect, in a possible implementation, the GUI further includes a voice input control, where in response to a detected user instruction in a voice format input for the voice input control, the user instruction in the voice format is sent to the server.

According to a fifteenth aspect, an embodiment of this disclosure further provides a computer program product including instructions. When the instructions are run on an electronic device, the electronic device is enabled to perform the command execution method according to any possible implementation of the first aspect.

According to a sixteenth aspect, an embodiment of this disclosure further provides a computer storage medium, including computer instructions. When the computer instructions are run on a terminal, the terminal is enabled to perform the command execution method according to any possible implementation of the first aspect.

According to a seventeenth aspect, an embodiment of this disclosure further provides a computer program product including instructions. When the instructions are run on an electronic device, the electronic device is enabled to perform the command execution method according to any possible implementation of the second aspect.

According to an eighteenth aspect, an embodiment of this disclosure further provides a computer storage medium, including computer instructions. When the computer instructions are run on a terminal, the terminal is enabled to perform the command execution method according to any possible implementation of the second aspect.

According to a nineteenth aspect, an embodiment of this disclosure further provides a computer program product including instructions. When the instructions are run on an electronic device, the electronic device is enabled to perform the command execution method according to any possible implementation of the third aspect.

According to a twentieth aspect, an embodiment of this disclosure further provides a computer storage medium, including computer instructions. When the computer instructions are run on a terminal, the terminal is enabled to perform the command execution method according to any possible implementation of the third aspect.

According to a twenty-first aspect, an embodiment of this disclosure further provides a computer program product including instructions. When the instructions are run on an electronic device, the electronic device is enabled to perform the command execution method according to any possible implementation of the fourth aspect.

According to a twenty-second aspect, an embodiment of this disclosure further provides a computer storage medium, including computer instructions. When the computer instructions are run on a terminal, the terminal is enabled to perform the command execution method according to any possible implementation of the fourth aspect.

### BRIEF DESCRIPTION OF DRAWINGS

To describe the technical solutions in the embodiments of the present disclosure or in the background more clearly, the following briefly describes the accompanying drawings for describing the embodiments of the present disclosure or the background.

FIG. 1A to FIG. 1E are schematic diagrams of structures of a GUI according to an embodiment of this disclosure;

FIG. 2A is a schematic diagram of a system architecture in scenario 1 according to an embodiment of this disclosure;

FIG. 2B is a schematic diagram of a system architecture in scenario 2 according to an embodiment of this disclosure;

FIG. 3 is a diagram of a system architecture according to an embodiment of this disclosure;

FIG. 4A is a schematic flowchart of a command execution method according to Method Embodiment 1 of this disclosure;

FIG. 4B(1) and FIG. 4B(2) are a schematic flowchart of another command execution method according to Method Embodiment 1 of this disclosure;

FIG. 4C is a schematic flowchart of an implementation of determining whether filling information of M slots is missing and obtaining missing filling information of a slot according to an embodiment of this disclosure;

FIG. 4D(1) and FIG. 4D(2) are a schematic flowchart of a command execution method according to Method Embodiment 2 of this disclosure;

FIG. 4E is a schematic flowchart of a command execution method according to Method Embodiment 3 of this disclosure;

FIG. 5 is a schematic flowchart of another command execution method according to Method Embodiment 4 of this disclosure;

FIG. 6A is a schematic flowchart of another command execution method according to Method Embodiment 5 of this disclosure;

FIG. 6B is a schematic flowchart of an implementation in which a terminal identifies a target intent of a user command according to an embodiment of this disclosure;

FIG. 7 is a schematic diagram of a structure of a command execution apparatus according to an embodiment of this disclosure;

FIG. 8 is a schematic diagram of a structure of another command execution apparatus according to an embodiment of this disclosure;

FIG. 9 is a schematic diagram of a structure of another command execution apparatus according to an embodiment of this disclosure;

FIG. 10 is a schematic diagram of a structure of another command execution apparatus according to an embodiment of this disclosure;

FIG. 11 is a schematic diagram of a structure of a terminal according to an embodiment of this disclosure; and

FIG. 12 is a schematic diagram of a structure of a server according to an embodiment of this disclosure.

### DESCRIPTION OF EMBODIMENTS

The following describes the embodiments of this disclosure with reference to the accompanying drawings in the embodiments of the present disclosure.

Professional terms and concepts in the embodiments of this disclosure are first described.

(1) User Command

In the field of human-computer dialogs, a user command is entered by a user, and may alternatively be referred to as a user requirement. In the embodiments of this disclosure, the user command may be one of or a combination of voice, an image, video, audio and video, text, and the like. For example, the user command is voice input by the user by using a microphone. In this case, the user command may alternatively be referred to as a “voice command”. In another example, the user command is text entered by the user by using a keyboard or a virtual keyboard. In this case, the user command may alternatively be referred to as a “text command”. In another example, the user command is an image entered by the user by using a camera, and the user enters “Who is the person in the image?” by using the virtual keyboard. In this case, the user command is a combination of the image and text. In another example, the user command is a segment of audio and video entered by the user by using the camera and the microphone. In this case, the user command may alternatively be referred to as an “audio and video command”.

(2) Speech Recognition

A speech recognition technology is alternatively referred to as automatic speech recognition (ASR), computer speech recognition, or speech to text (STT) recognition, and is a method for converting human voice into corresponding text by using a computer.

When a user command is a voice command or a command including voice, the user command may be converted into text by using the ASR. Usually, a working principle of the ASR is as follows: Step 1, an audio signal entered by the user is split by frame to obtain frame information; step 2, the obtained frame information is recognized as a state, where several pieces of frame information correspond to one state; step 3, the states are combined into phonemes, where every three states are combined into one phoneme; and step 4, the phonemes are combined into words, where several phonemes are combined into one word. It can be learned that a speech recognition result is obtained provided that a state corresponding to each frame of information is known. How to determine the state corresponding to each frame of information? Usually, it may be considered that if a probability at which to-be-identified frame information corresponds to a state is highest, the frame information corresponds to the state.

In a speech recognition process, an acoustic model (AM) and a language model (LM) may be used to determine a group of word sequences corresponding to one piece of voice. The acoustic model may be understood as modeling of sound production, and can convert a voice input into an acoustic output, to be specific, decode acoustic features of one piece of voice into units such as phonemes or words. More precisely, a probability at which the voice belongs to an acoustic symbol (for example, a phoneme) is provided. The language model provides a probability at which a group of word sequences is the piece of voice, to be specific, decodes words into a group of word sequences (namely, a complete sentence).

(3) Natural Language Understanding (NLU)

Natural language understanding is to expect machines to have a language understanding ability as normal humans. One of important functions is intent identification. For example, a user command is “How far is Hilton Hotel from Baiyun Airport?”, and then an intent of the user command is to “query the distance”. Slots configured for the intent include a “starting place” and a “destination”, information about the slot “starting place” is “Hilton Hotel”, and information about the slot “destination” is “Baiyun Airport”. With the intent and slot information, the machine can respond.

(4) Intent and Intent Identification

The intent identification is to identify what a user command indicates to do specifically. The intent identification may be understood as a problem of semantic expression classification, or in other words, the intent identification is a classifier (alternatively referred to as an intent classifier in the embodiments of this disclosure), to determine an intent of the user command. Commonly used intent classifiers for intent identification include a support vector machine (SVM), a decision tree, and deep neural network (DNN). The deep neural network may be a convolutional neural network (CNN), a recurrent neural network (RNN), or the like, and the RNN may include a long short-term memory (LSTM) network, a stacked recurrent neural network (SRNN), or the like.

A general process of intent identification includes: first, preprocessing a corpus (namely, a group of word sequences), for example, removing punctuation marks and stop words of the corpus; second, using a word embedding algorithm, such as a word2vec algorithm, to generate word embedding from the preprocessed corpus, and further, using an intent classifier (such as an LSTM network) to perform feature extraction, intent classification, and other work. In the embodiments of this disclosure, the intent classifier is a trained model, and can identify intents in one or more scenarios, or identify any intent. For example, the intent classifier can identify an intent in an air ticket booking scenario, including booking an air ticket, filtering an air ticket, querying an air ticket price, querying air ticket information, returning an air ticket, changing an air ticket, and querying a distance to an airport. In another example, the intent classifier can identify intents in a plurality of scenarios.

(5) Slot

After the user intent is determined, an NLU module needs to further understand content in a user command. For simplicity, the core part may be selected for understanding, and other parts may be ignored. Those most important parts may be referred to as slots. In other words, a slot is a definition of key information in a user expression (for example, a group of word sequences identified in the user command). One or more slots may be configured for the intent of the user command, so that information about the slots can be obtained, and a machine can respond to the user command. For example, in an intent of booking an air ticket, slots include “take-off time”, “starting place”, and “destination”. These three pieces of key information need to be identified during natural language understanding (NLU). To accurately identify slots, slot-types need to be used. The foregoing example is used. If you want to accurately identify the three slots: “take-off time”, “starting place”, and “destination”, corresponding slot-types behind, respectively: “time” and “city name”, are required. The slot-type is a structured knowledge base of specific knowledge, for identifying and converting slot information expressed colloquially by users. From the perspective of a programming language, intent+slot may be considered as a function to describe a user requirement, where “an intent corresponds to a function”, “a slot corresponds to a parameter of the function, and “slot_type corresponds to a type of the parameter”. Slots configured for different intents may be divided into necessary slots and optional slots, where the necessary slot is a slot that needs be filled to execute the user command, and the optional slot is a slot that may be selectively filled or not filled, upon selection, to execute the user command. Unless otherwise specified, the slot in this disclosure may be a necessary slot or an optional slot.

In the foregoing example of “air ticket booking”, three core slots are defined, respectively: “take-off time”, “starting place”, and “destination. If content that needs to be entered by a user to book an air ticket is fully considered, more slots can be certainly thought of, such as a quantity of passengers, an airline company, an airport of departure, and an airport of landing. A slot designer may design the slots based on a granularity of the intent.

(6) Slot Filling

Slot filling is to extract a structured field in a user command, or in other words, to read some semantic components in a sentence (the user command in the embodiments of this disclosure). Therefore, slot filling may be considered as a sequence labeling problem. The sequence labeling problem includes word segmentation, part-of-speech labeling, named entity recognition (named entity recognition, NER), keyword extraction, semantic role labeling, and the like in natural language processing. When a specific tag set is given during sequence labeling, sequence labeling can be performed. Methods for resolving the sequence labeling problem include a maximum entropy Markov model (MEMM), a conditional random field (CRF), a recurrent neural network (RNN), and the like.

Sequence labeling is to label each character in a given text, and is essentially a problem of classifying each element in a linear sequence based on context content. That is, for a one-dimensional linear input sequence, each element in the linear input sequence is labeled with a tag in the tag set. In the embodiments of this disclosure, a slot extraction classifier may be used to label a slot for text of the user command. In NLU in the embodiments of this disclosure, the linear sequence is the text of the user command (text entered by a user or text into which an input speech is recognized). A Chinese character may be usually considered as an element of the linear sequence. For different tasks, the tag set represents different meanings. Sequence labeling is to label the Chinese character with a suitable tag based on context of Chinese character, that is, to determine a slot of the Chinese character.

For example, when filling information of a slot is missing in the user command, for example, the user command is “How far is this hotel from Hongqiao Airport?”, in response to the user command, a machine needs to know which hotel “this hotel” refers to. In a conventional technology, the machine may ask the user “The distance from which hotel to Hongqiao Airport do you want to query?”, to obtain information about the slot entered by the user. It can be learned that, the machine needs to interact with the user for a plurality of times to obtain the missing information about the slot in the user command.

(7) A user interface (UI) is a medium interface for interaction and information exchange between an application or an operating system and a user. The user interface implements conversion between an internal form of information and a form acceptable to the user. A user interface of an application is source code written in a specific computer language such as Java or an extensible markup language (XML). Interface source code is parsed and rendered on an electronic device, and is finally presented as content that can be identified by the user, for example, a control such as a picture, a text, or a button. A control is also referred to as a widget, and is a basic element of the user interface. Typical controls include a toolbar, a menu bar, a text box, a button, a scroll bar, a picture, and a text. An attribute and content of a control on the interface are defined by using a tag or a node. For example, the control included in the interface is defined in the XML by using a node such as <Textview>, <ImgView>, or <VideoView>. One node corresponds to one control or attribute on the interface. After being parsed and rendered, the node is presented as content visible to the user. In addition, interfaces of a plurality of applications such as a hybrid application usually further include a web page. The web page is also referred to as a page, and may be understood as a special control embedded into an interface of an application. The web page is source code compiled in a specific computer language such as a hypertext markup language (HTML), a cascading style sheet (CSS), or JavaScript (JS). A browser or a web page display component whose function is similar to that of the browser may load and display the web page source code as content that can be identified by the user. Specific content included in the web page is also defined by using a label or a node in the web page source code. For example, in GTML, an element and an attribute of the web page is defined by using <p>, <video>, or <canvas>.

(8) Graphic User Interface (GUI)

The GUI is a user interface, and a common representation form of the user interface is a graphical user interface (GUI), which is a user interface that is related to a computer operation and that is displayed in a graphical manner. The user interface may include interface elements such as windows and controls displayed on a display screen of an electronic device. The controls may include visual interface elements such as an icon, a button, a menu, a list, a tab, a text box, a dialog box, a status bar, a navigation bar, and a widget. UI attributes such as a size, a style, and a color designed by a GUI designer for interface elements may be defined in interface source code and resource files of an application.

The electronic device may present the interface elements in the user interface of the application by drawing one or more drawing elements such as a geometry, text, and a picture. Herein, the application may include a desktop program (Launcher). For example, for an application icon in a home screen, the electronic device may present the application icon by drawing a foreground picture representing the icon. In another example, for a pop-up window, the electronic device may present the pop-up window by drawing a graphic (a shape of the pop-up window), a picture (a background of the pop-up window), and text (text displayed in the pop-up window).

A user interacts with the GUI mainly through tapping and gestures. The computer does not know what the user is doing. The computer only converts the tapping and gestures into two types of data: coordinates and operations, and then provides corresponding response events, for example, opening a link and obtaining database information.

(9) Voice User Interface (VUI)

A user interacts with the VUI in a manner of a dialog. A natural language used during the dialog is unstructured data. To provide a correct response event, the VUI needs to first understand what humans are saying and, more importantly, what they are thinking.

A GUI information architecture includes a page and a process. The page includes various layouts and structures. However, a VUI information architecture includes only a process. Therefore, the GUI information architecture is more complex than the VUI information architecture. Due to a limitation of page operations, the GUI cannot switch irrelevant processes at will, and the VUI that performs communication through dialogs can do this. The VUI is superior to the GUI in terms of convenience of navigation.

(10) GUI Information

The GUI information is service data corresponding to a control on a GUI, or is the service data corresponding to the control on the GUI and data entered by a user for the control. When detecting that the user performs an operation on the control, a terminal may store or update the GUI information corresponding to the control. The service data may be structured data described by using XML, JSON, or the like, and is interaction data between an application to which the GUI belongs and a server of the application. It should be understood that, in some embodiments, the terminal does not store GUI information corresponding to all controls, and GUI information corresponding to controls operated by the user is stored. In some embodiments, the terminal may store GUI information respectively corresponding to some controls even if the controls are not operated by the user. For example, after receiving response information sent by the server, for example, information about a plurality of hotels (for example, a hotel h1 and a hotel h2), the terminal may display GUI information (information about the hotel h1) corresponding to a control c1. In this case, the terminal may store the information about the hotel h1 corresponding to the control c1, where the information about the hotel h1 corresponds to a slot “currently displayed hotel”. In another example, the terminal may further store information about the hotel h2 corresponding to a control c2, where the information about the hotel h1 and the information about the hotel h2 correspond to a slot “list of selected hotels”.

The foregoing stored GUI information corresponding to all controls forms a first GUI information set.

It should be understood that input data for a control may be operation information for the control, and the operation information may include an operation type (for example, a tap or a double-tap), a time at which/for which the control is operated, and the like.

In some embodiments, GUI information corresponding to the control is information displayed on a GUI for the control. In some other embodiments, the GUI information corresponding to the control is not the information displayed on the GUI interface for the control, but is used to draw service data corresponding to the control.

For example, in a hotel booking scenario, a GUI may display a plurality of hotel cards. Description is provided by using an example in which one hotel card is one control. One hotel card may be used to describe one hotel, and hotel information displayed on one hotel card control may not be all information corresponding to the control. When the hotel card is tapped, the terminal outputs detailed information of the hotel specified by the hotel card, and GUI information corresponding to the control is the detailed information of the hotel.

In the embodiments of this disclosure, the terminal may construct a correspondence between GUI information and slots, so that the terminal can determine GUI information corresponding to a slot that lacks filling information. It should be understood that the filling information of the slot may be obtained by using the GUI information corresponding to the slot. Alternatively, the filling information of the slot is the GUI information corresponding to the slot.

In some embodiments, the terminal may store <identifiers of controls, GUI information>, that is, a correspondence between the identifiers of the controls on the GUI and the GUI information, so that the terminal can add, delete, modify, and read, based on an identifier of a control, GUI information corresponding to the identifier of the control. If an identifier of a control corresponds to GUI information at a plurality of moments, the GUI information further includes time information, and the time information may indicate a time at which GUI information corresponding to the control is stored, or a time at which GUI information corresponding to the control is generated by performing an operation on the control.

In some embodiments, the terminal does not store the foregoing <identifiers of controls, GUI information>, and instead, stores <slots, GUI information> or <(intents, slots), GUI information>, that is, the terminal stores a correspondence between the slots and the GUI information, or a correspondence between the intents, the slots, and the GUI information, so that the terminal can quickly determine, based on a slot, GUI information corresponding to the slot. It should be understood that an intent may correspond to one or more slots, or may not correspond to a slot.

The foregoing stored correspondence may be stored by using a map data structure, where map is a container that stores elements based on a key, and is implemented by using an array and a linked list.

The foregoing is described by using an example in which the terminal stores the GUI information. It should be understood that, in another implementation, the GUI information may be stored in a server or a cloud environment.

An embodiment of this disclosure provides a command execution method. In a process of interactions between a terminal and a user, a server configured to execute a user command or the terminal may store slots and GUI information corresponding to the slots, and when filling information of slots configured for the user command is missing, the server configured to execute the user command may obtain the missing filling information of the slots from the stored GUI information, to avoid a plurality of interactions between the user and the terminal. This is more intelligent, and improves command execution efficiency.

For example, when the user command is “How far is this hotel from Hongqiao Airport?”, filling information of a slot “current hotel” is missing, and the terminal stores GUI information corresponding to the slot “current hotel”, that is, a currently displayed hotel. If the currently displayed hotel is “hotel A”, the terminal sends “hotel A” to the server configured to execute the user command, and further, the server obtains the filling information of the slot “current hotel”, and executes the user command based on an obtained intent of the user command and the filling information of the slots configured for the intent, to obtain response information, which is a distance/drive distance between the hotel A and Hongqiao Airport in this scenario. In another implementation, the server configured to execute the user command may alternatively store the GUI information corresponding to the slot “current hotel”. In this case, the server may obtain the filling information of the slot “current hotel” from the stored GUI information corresponding to the slot “current hotel”.

The following describes a data processing method, a terminal that performs the method, and a user interface on the terminal according to an embodiment of this disclosure.

The terminal may include a processor, a memory, a display, and the like. The display may be a touch or display screen, configured to display a GUI. The GUI may include at least one control. The data processing method may include: When detecting a user operation input for a first control on the GUI, the terminal obtains GUI information corresponding to the first control.

In some embodiments, the GUI is provided by a first application of the terminal, and the data processing method may further include: The terminal stores or updates an identifier of the first control and the GUI information corresponding to the first control. In this case, a server configured to provide a service for the first application may request the GUI information from the terminal.

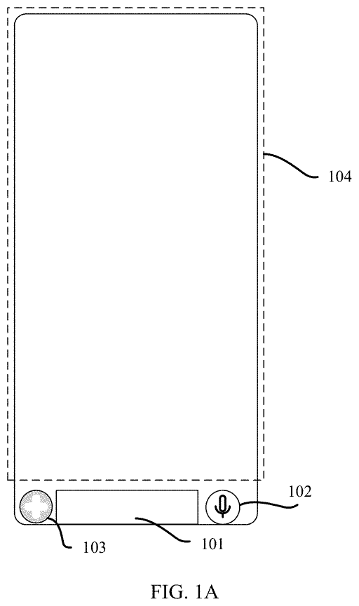

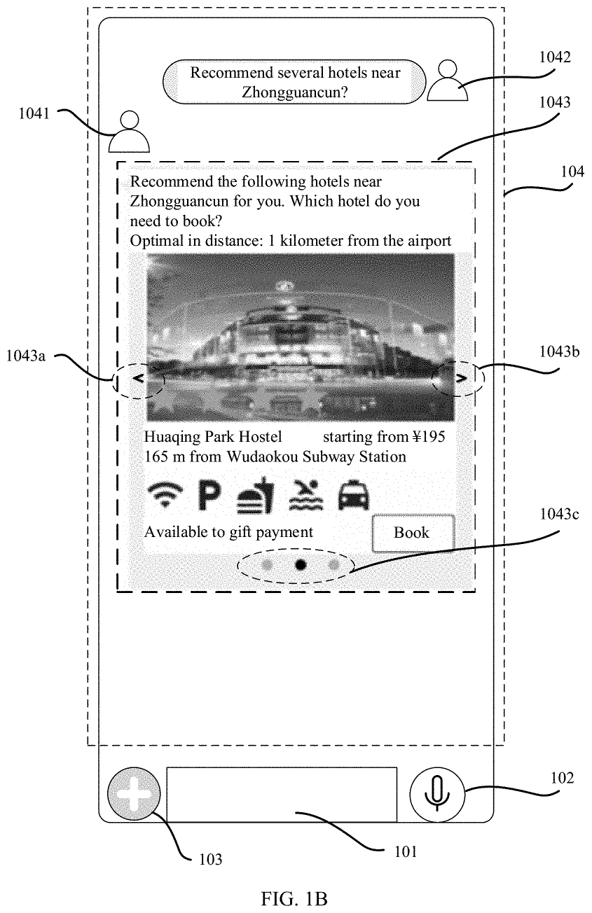

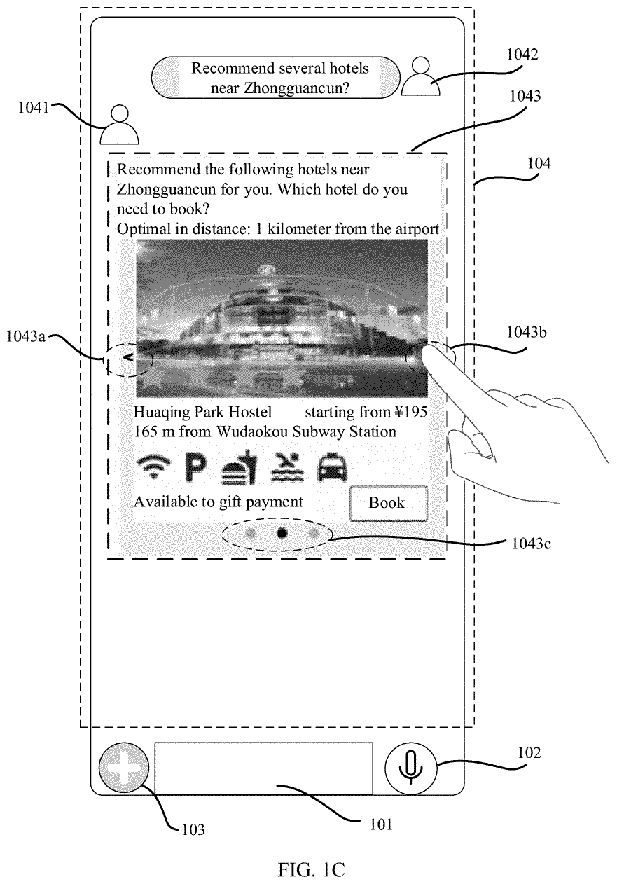

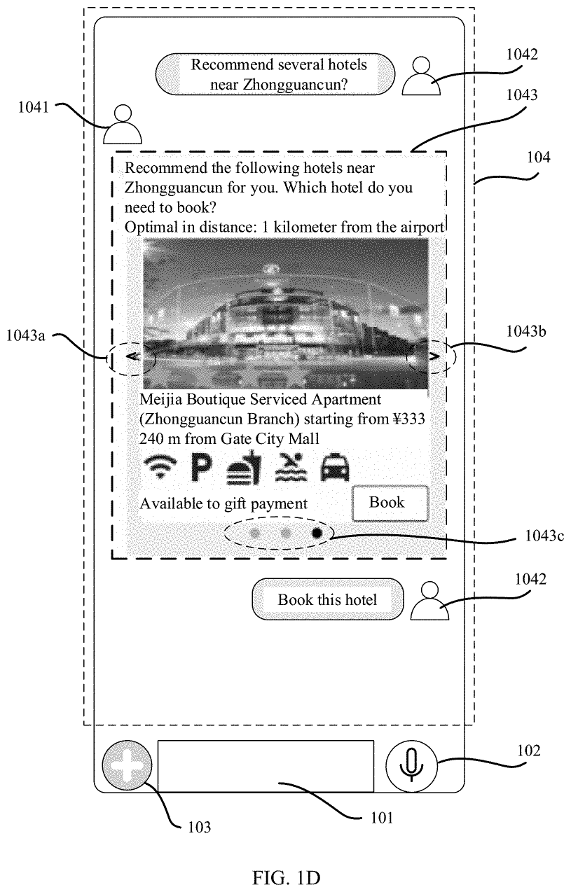

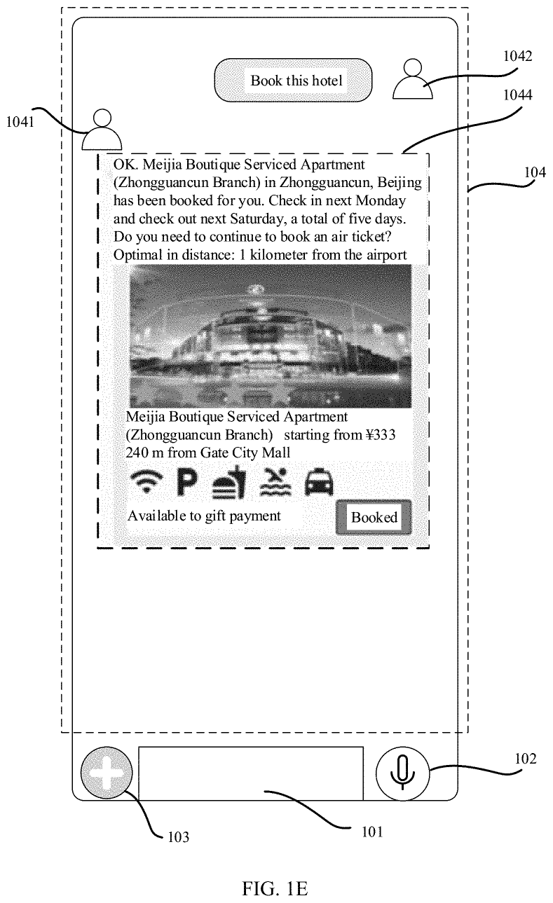

FIG. 1A is a schematic diagram of a structure of a GUI according to an embodiment of this disclosure. The GUI may include a text input control 101, a voice input control 102, and the like.

In response to a detected user command in a text format input for the text input control 101, the terminal generates a request R₁ based on the user command, and sends the request R₁ to the business server. The request R₁ is used to request the business server to execute the user command. After obtaining response information of the user command, the business server sends the response information to the terminal.

In response to a detected user command in a voice format input for the voice input control 102, the terminal generates a request R₂ based on the user command, and sends the request R₂ to the business server. The request R₂ is used to request the business server to execute the user command. After obtaining response information of the user command, the business server sends the response information to the terminal. In an implementation, the request R₂ carries the user command. In another implementation, the request R₂ carries indication information used to indicate the user command. In response to the detected user command in the voice format input for the voice input control 102, the terminal sends the user command in the voice format to a speech recognition server, so that the speech recognition server recognizes text of the user command, and sends the obtained user command in the text format to the business server.

Optionally, as shown in FIG. 1A, the GUI further includes an extended application control 103. In response to a user operation, such as a tap operation, input for the extended application control 103, the terminal may display a first display area, where the first display area includes a plurality of controls, for example, a picture input control, a camera control, and an attachment control, to send a user command in another format to the execution server.

As shown in FIG. 1A, the GUI may further include a display container 104. The display container 104 is configured to display information about interactions between a command execution device and the terminal.

For example, a user taps the voice input control 102, and the terminal detects the operation, turns on a microphone, and acquires, by using the microphone, voice input by the user, that is, a user command in a voice format. For example, the user command is “Recommend several hotels near Zhongguancun?”, and the terminal requests the server to execute the user command.

In some embodiments, after the response information sent by the business server for the user command is received, if wanting to display the information, the terminal draws the GUI shown in FIG. 1B, and the display container 104 may display a first control, including the response information.

As shown in FIG. 1B, the display container 104 displays an icon 1041 of the business server, an icon 1042 of the user, and at least one first control, where the at least one first control includes controls such as controls 1043a and 1043b. One first control may correspond to response information or some response information. It should be understood that although the first control is used for description in FIG. 1B, it should be understood that identifiers of the first controls are different, and information respectively corresponding to the first controls is different.

As shown in FIG. 1B, the terminal may draw the response information on a plurality of pages. For example, when the execution server recommends three hotels for the user command “Recommend several hotels near Zhongguancun?”, three pages may be displayed, and one page may display information about one or more hotels. As shown in the figure, on a page 1043, the user may tap the control 1043a or 1043b for switching. The display container 104 may further include a control 1043c, configured to indicate a location of a current page in a plurality of pages.

In response to the control 1043a, the terminal displays content of a page previous to the current page, and updates stored GUI information corresponding to the control 1043a. For example, GUI information corresponding to a slot “currently displayed hotel” is updated to information about hotels displayed on the previous page.

In response to the control 1043b, the terminal displays content on a page next to the current page, and updates stored GUI information corresponding to the control 1043b. For example, the GUI information corresponding to the slot “currently displayed hotel” is updated to information about hotels displayed on the next page. As shown in FIG. 1C, when the user taps the control 1043b, the user switches to the next page.

As shown in FIG. 1D, if the user enters a user command “Book this hotel”, the server may identify that an intent of the user command “Book this hotel” is to “book the currently displayed hotel”. In this case, filling information of the slot “currently displayed hotel” is missing. The user may obtain, from stored GUI information, that a hotel corresponding to the slot “currently displayed hotel” is “Meijia Boutique Serviced Apartment (Zhongguancun Branch)”. Further, the server may book this hotel, and return a result to the terminal after completing the booking, as shown in FIG. 1E.

It should be understood that FIG. 1A to FIG. 1E are merely examples for description. It should be understood that the GUI of the terminal in the embodiments of this disclosure may alternatively be designed in other manners. This is not limited herein.

In some other embodiments, the method may further include: The terminal sends the identifier of the first control and the GUI information corresponding to the first control to the server. In an implementation, the GUI is provided by the first application, and the server is configured to provide a service for the first application. In another implementation, the GUI is provided by a second application, and that the terminal obtains the GUI information corresponding to the identifier of the first control is specifically: A third application of the terminal obtains the GUI information corresponding to the identifier of the first control, and the server is configured to provide a service for the third application. Both the first application and the second application are applications running on the terminal.

The following describes a scenario to which the embodiments of this disclosure may be applied.

Scenario 1:

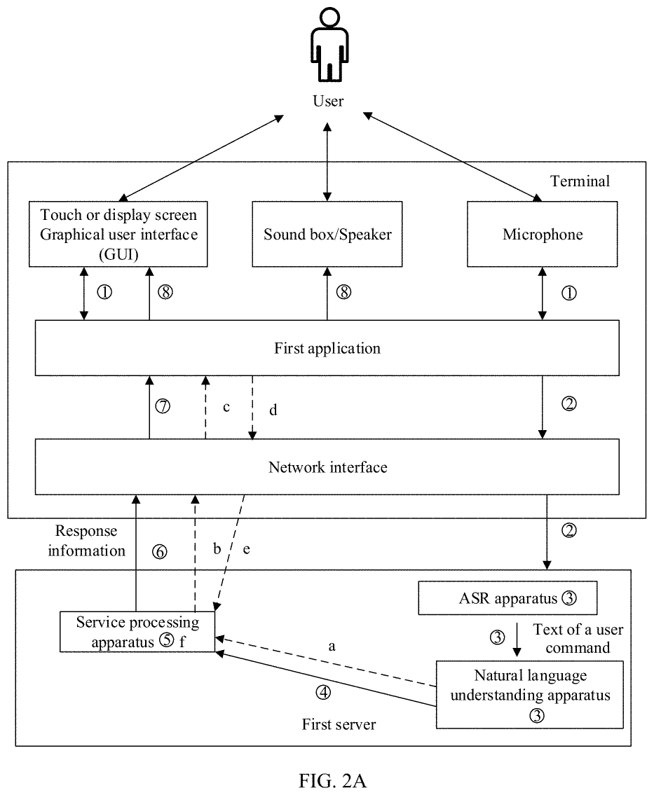

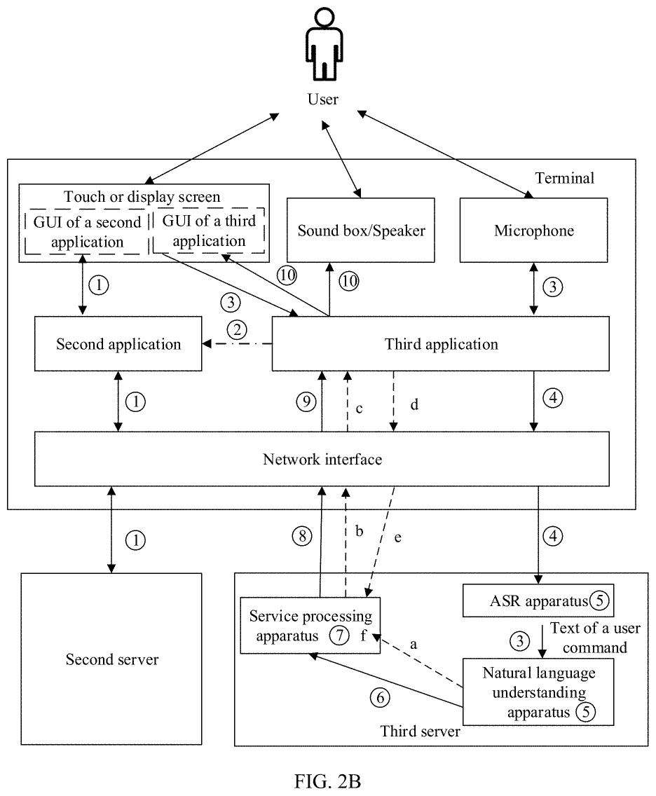

FIG. 2A is a schematic diagram of interactions between a user, a terminal, and a server in scenario 1. A process of interactions between the user, the terminal, and the server may include: 1. In a process in which the user uses the first application on the terminal, the first application monitors a user operation in real time, and the first application of the terminal or a first server stores a correspondence between controls on a user interface of the first application and GUI information, a correspondence between slots and GUI information, and the like; the first application may be an application of a type such as “Ctrip”, “Fliggy”, or “Taobao”, or another application; the user interface provided by the first application may include a text input control and a voice input control; the text input control is configured to receive a user command in a text format entered by the user, and the voice input control is configured to receive a user command in a voice format entered by the user; for example, after detecting a pressing operation for the voice input control, the terminal turns on the microphone, and acquires voice by using the microphone; 2. the first application sends the user command in the voice format to an ASR apparatus of the first server by using a network interface; 3. the first server first recognizes text of the user command by using the ASR apparatus, and further identifies a target intent of the user command by using a natural language understanding apparatus; 4. the natural language understanding apparatus sends the target intent and filling information of slots configured for the target intent to a service processing apparatus; 5. the service processing apparatus executes the user command based on the target intent, the filling information of the slots configured for the target intent, and the like, to obtain response information of the user command; 6. the service processing apparatus sends the response information to the first application of the terminal; 7. the terminal receives the response information by using the network interface, and the terminal transmits the response information to the first application; and 8. the first application of the terminal displays the response information by using a display screen or plays the response information by using a sound box/speaker.

In another implementation, the terminal detects text entered by the user for the text input control of the touch or display screen, and then the terminal sends the user command in the text format to the first server by using the network interface, and the first server identifies the target intent of the user command through natural language understanding. Further, the first server executes the user command based on the target intent and the filling information of the slots configured for the target intent, to obtain the response information of the user command, and further, the terminal receives the response information by using the network interface.

If the terminal stores the GUI information, when the first server identifies that the filling information of the slots configured for the user command is missing, the first server obtains the missing filling information of the slots by interacting with the terminal. As shown in FIG. 1A, the process may include: a, the natural language understanding apparatus of the first server requests the missing filling information of the slots from a service processing module, or indicates the service processing module to obtain the missing filling information of the slots; b, the service processing module sends a request to the first application of the terminal, to request the missing filling information of the slots; c, the first application of the terminal receives the request by using the network interface; d, the first application parses the request and obtains the missing filling information of the slots from the stored GUI information; e, the first application sends the missing filling information of the slots to the service processing module of the first server by using the network interface; and f, the service processing module of the first server receives the missing filling information of the slots, to further implement the foregoing 4 and 5.

If the first server stores the GUI information, the terminal needs to update the GUI information to the first server in real time. In this way, when the first server identifies that the filling information of the slots configured for the user command is missing, the first server determines the missing filling information of the slots from the stored GUI information.

In the foregoing scenario 1, to support the functions provided in the embodiments of this disclosure, the first application needs to have a function of storing GUI information, so that the terminal finds the missing filling information of the slots from the stored GUI information. In this case, the first server provides a service for the first application on the terminal.

For example, the first application “Ctrip” needs to store a correspondence between controls on a user interface of the first application “Ctrip” and GUI information, a correspondence between GUI information and slots, and the like. In this case, the first server may be a device that provides a service for the application “Ctrip”, for example, a server of “Ctrip”.

Scenario 2:

As shown in a schematic diagram of interactions between a user, a terminal, and a server in scenario 2 shown in FIG. 2B, the process may include: 1. The user is using the second application on the terminal, where the second application may be an application of a type such as “Ctrip”, “Fliggy”, or “Taobao”, and the user performs an operation on a user interface provided by the second application, and performs information exchange with a second server, where the second server provides a service for the second application on the terminal; 2. in an execution process of 1, the third application of the terminal monitors, in real time, an operation performed by the user on the user interface of the second application, where the third application of the terminal or a third server stores a correspondence between controls on the user interface of the second application and GUI information, a correspondence between GUI information and slots, and the like; 3. the user enters a user command in a text format by using a user interface of the third application, or enters a user command in a voice format by using a VUI of the third application, where the user interface of the third application may include a text input control and/or a voice input control, and the VUI interface of the third application may include a voice input control; the text input control is configured to receive the user command in the text format entered by the user, and the voice input control is configured to receive the user command in the voice format entered by the user; for example, after detecting a pressing operation for the voice input control of the user interface of the third application, the terminal turns on the microphone, and acquires voice by using the microphone; 4. the third application sends the user command in the voice format to the third server by using a network interface; 5. the third server first identifies text of the user command by using the ASR apparatus, and then identifies the target intent of the user command by using the natural language understanding apparatus; 6. the natural language understanding apparatus sends, to the service processing apparatus, the target intent and the filling information of the slots configured for the target intent; 7. the service processing apparatus executes the user command based on the target intent, the filling information of the slots configured for the target intent, and the like, to obtain the response information of the user command; 8 the service processing apparatus sends the response information to the third application of the terminal; 9. the third application of the terminal receives the response information by using the network interface; and 10. the third application of the terminal displays the response information by using the display screen, or plays the response information by using the sound box/speaker.

In another implementation, the third application of the terminal detects the text entered by the user for the text input control of the display screen, and further, the third application of the terminal sends the user command in the text format to the third server by using the network interface, and the third server identifies the target intent of the user command through natural language understanding. Further, the third server executes the user command based on the target intent, the filling information of the slots configured for the target intent, and the like, to obtain the response information of the user command, and sends the response information to the third application of the terminal, so that the third application of the terminal receives the response information by using the network interface.

If the terminal stores the GUI information, when the third server identifies that the filling information of the slots configured for the user command is missing, the third server obtains the missing filling information of the slots by interacting with the terminal. As shown in FIG. 2B, the process may include: a, the natural language understanding apparatus of the third server requests the missing filling information of the slots from the service processing module; b, the service processing module sends a request to the third application of the terminal, to request the missing filling information of the slots; c, the third application of the terminal receives the request by using the network interface; d, the third application parses the request and obtains the missing filling information of the slots from the stored GUI information; e, the third application sends the missing filling information of the slots to the service processing module of the third server by using the network interface; and f, the service processing module of the third server receives the missing filling information of the slots, to further implement the foregoing 6 and 7.

If the third server stores the GUI information, the terminal needs to update the GUI information to the third server in real time. In this way, when the third server identifies that the filling information of the slots configured for the user command is missing, the third server determines the missing filling information of the slots from the stored GUI information.

In the foregoing scenario 2, the second application may not be improved, and the second application needs to provide a permission that data on the GUI of the second application is read by the third application and that the controls on the GUI of the second application are monitored by the third application. For example, the second application “Ctrip” provides a permission that data on the GUI of the second application “Ctrip” is read by the third application and that the controls on the GUI of the second application “Ctrip” are monitored by the third application.

To support the functions provided in the embodiments of this disclosure, the third application needs to have a permission and a function of monitoring the data and the controls on the GUI of the second application, and may store the GUI information, so that the second application finds the missing filling information of slots from the stored GUI information. It should be understood that the third application may be an operating system layer application, or may be an application layer application. This is not limited in this disclosure.

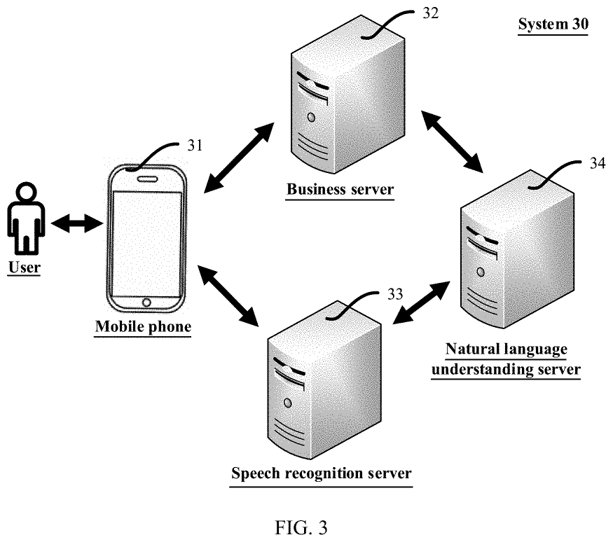

The following describes a system related to the embodiments of this disclosure. As shown in FIG. 3, the system 30 may include:

A terminal 31 may receive a user command in a voice format acquired by a user by using a voice obtaining apparatus, or receive a user command in a text format entered by the user on the terminal 31. The user command in the voice format and the user command in the text format may be collectively referred to as a user command. After receiving the user command entered by the user, the terminal 31 may send a request to a business server 32 based on a client, to request the business server 32 to execute the user command.

If the user command received by the terminal 31 is the user command in the text format, the terminal 31 may directly request the business server 32 to execute the user command. If the user command received by the terminal 31 is the user command in the voice format, in an implementation 1, the terminal 31 may send an input voice stream to a speech recognition server 33 in real time, and after obtaining the user command in the voice format, the speech recognition server 33 recognizes text of the user command in the voice format, to obtain the user command in the text format; and further, the speech recognition server 33 may send the obtained user command in the text format to the business server 32. In an implementation 2, after the speech recognition server 33 obtains the user command in the text format in the foregoing implementation 1, the speech recognition server 33 may send the user command in the text format to the terminal 31, and in this case, the terminal 31 obtains the user command in the text format, and may request the business server 32 to execute the user command. In an implementation 3, after receiving the voice stream, that is, the user command in the voice format, the terminal 31 recognizes the text of the voice stream to obtain the user command in the text format, and may further request the business server 32 to execute the user command. In an implementation 4, the terminal 31 sends the user command in the voice format to the business server 32, and when recognizing that the user command is voice, the business server 32 requests the speech recognition server 33 to recognize the user command in the voice format, and the speech recognition server 33 recognizes the voice command, to obtain the user command in the text format, and further sends the user command in the text format to the business server 32.

After receiving the user command in the text format (hereinafter referred to as a user command for short), the business server 32 may identify an intent of the text command by using a natural language understanding server 34 (it should be understood that the intent identified by the server in this application is also referred to as a target intent because of a high accuracy rate). Further, the natural language understanding server 34 determines whether filling information of slots configured for the target intent is missing. If the filling information of the slots configured for the target intent is missing, the command execution server may further identify whether the missing filling information of the slots can be obtained by using a first GUI information set, and if the missing filling information of the slots can be obtained by using the first GUI information set, the business server 32 may send, to the terminal 31, a request used to request the missing filling information of the slots, to obtain the missing filling information of the slots. After obtaining the target intent and the filling information of each slot in the slots configured for the target intent, the business server 32 may execute the user command, and further obtain response information of the user command, and then sends the response information to the terminal 31.

After receiving the response information, the terminal 31 may display the response information by using a user interface, or may output the response information by using a voice output module. For details, refer to related descriptions in the user interface in which the terminal 31 outputs the response information in FIG. 3. Details are not described herein again.

The speech recognition server 33 is configured to recognize text of voice. In some embodiments, the speech recognition server 33 and the business server 32 may alternatively be a same device, and the business server 32 includes a unit or module configured to implement speech recognition.

In some embodiments, the user may interact with the business server 32 by using the user interface shown in FIG. 1A to FIG. 1E in the terminal 31, and interact with the speech recognition server 33 by using a VUI interface in the terminal 31.

In some embodiments, the system further includes the natural language understanding (NLU) server. The natural language understanding server 34 is configured to: identify the target intent of the user command based on the input user command in the text format, obtain a plurality of slots configured for the target intent, and extract filling information of the slots from the user command, and further send, to the command execution server, the identified target intent of the user command, the plurality of slots configured for the target intent, and the filling information of the slots that is extracted from the user command. The business server 32 responds to the user command based on the target intent, the plurality of slots, and the filling information of the plurality of slots.

In some embodiments, subsystems and functional units included in the servers such as the business server 32, the natural language understanding (NLU) server, and the speech recognition server 33 may be deployed in a cloud environment, and specifically, one or more computing devices in the cloud environment. The cloud environment indicates a central computing device cluster that is owned by a cloud service provider and that is used to provide computing, storage, and communication resources.

It should be understood that, deployment forms of the subsystems and the functional units included in the servers such as the business server 32, the natural language understanding (NLU) server, and the speech recognition server 33 are relatively flexible on a hardware device. In the embodiments of this disclosure, some or all subsystems and functional units included in the natural language understanding (NLU) server or the speech recognition server 33 may also be deployed in the business server 32. Similarly, some or all subsystems and functional units included in the business server 32 may also be deployed in the NLU server or the speech recognition server 33.

With reference to the foregoing scenario 1, the terminal 31 may run the first application, the business server 32 may be the service processing apparatus in the foregoing first server, the natural language understanding server 34 may be the natural language understanding apparatus in the foregoing first server, and the speech recognition server 33 may be the speech recognition apparatus in the foregoing first server. With reference to the foregoing scenario 2, the terminal 31 may run the first application and the second application, the business server 32 may be the service processing apparatus in the foregoing third server, the natural language understanding server 34 may be the natural language understanding apparatus in the foregoing third server, and the speech recognition server 33 may be the speech recognition apparatus in the foregoing third server.

The following describes implementations provided in the embodiments of this disclosure. The command execution method in the embodiments of this disclosure may be implemented based on the foregoing scenario 1 and scenario 2, and the system 30.

### Embodiment 1

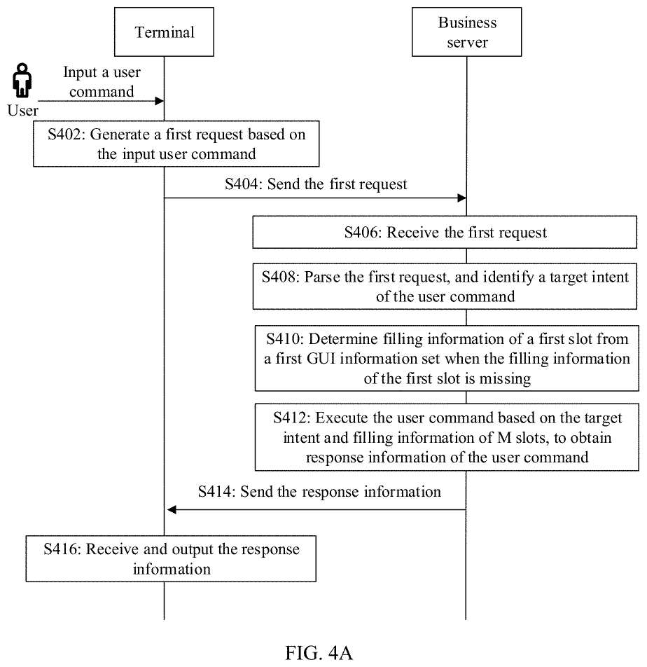

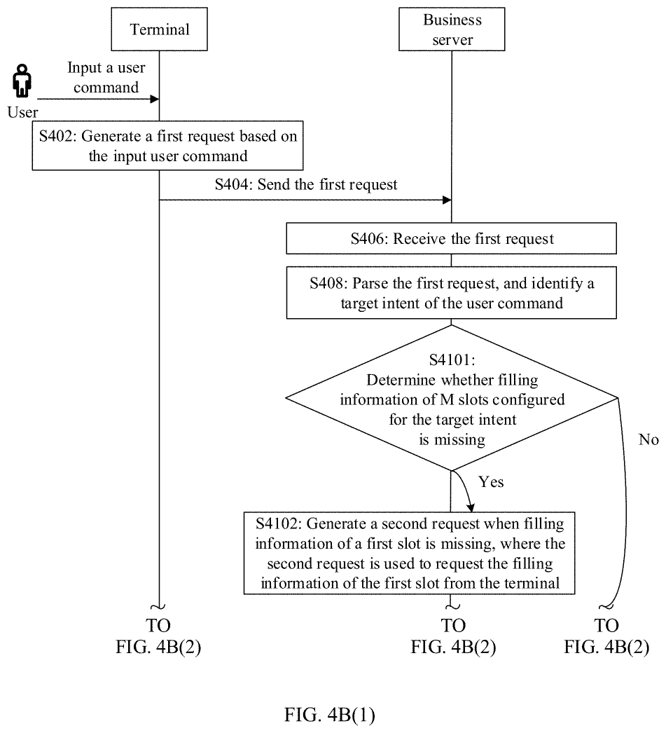

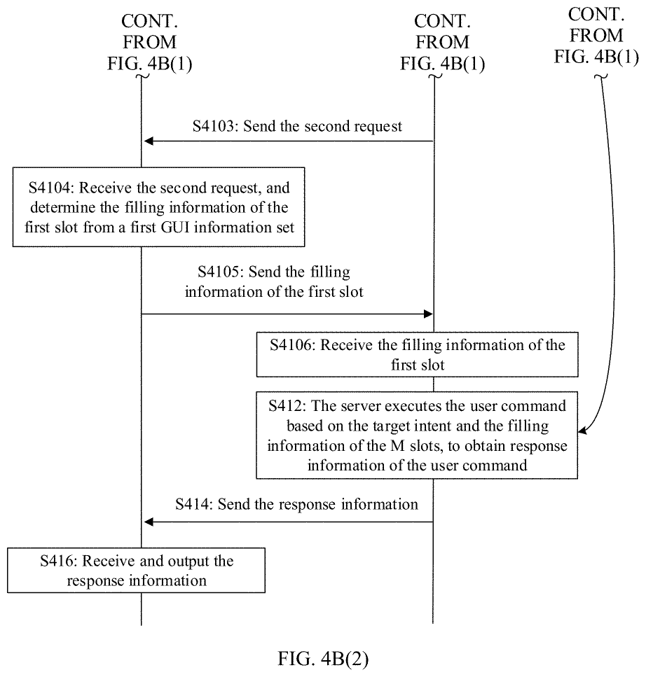

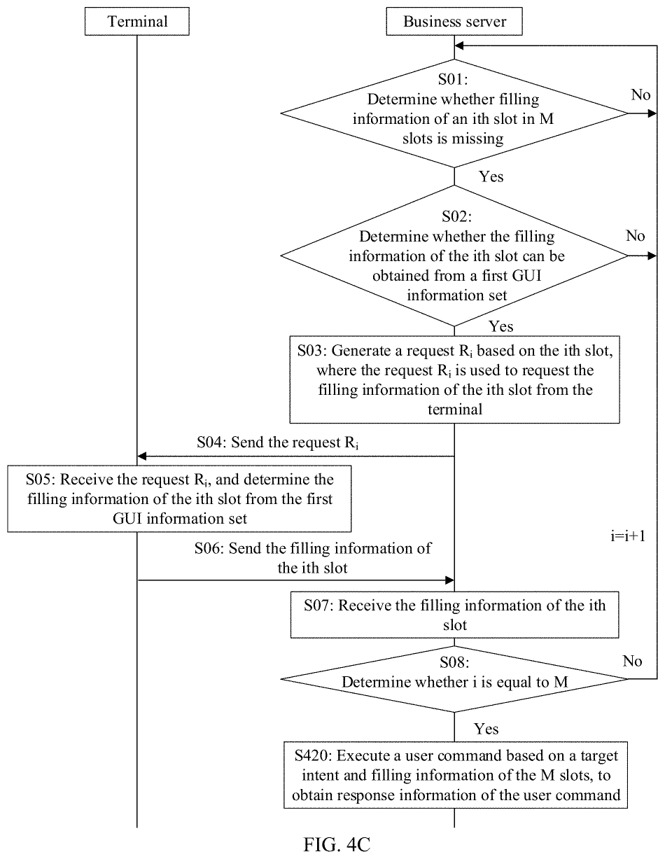

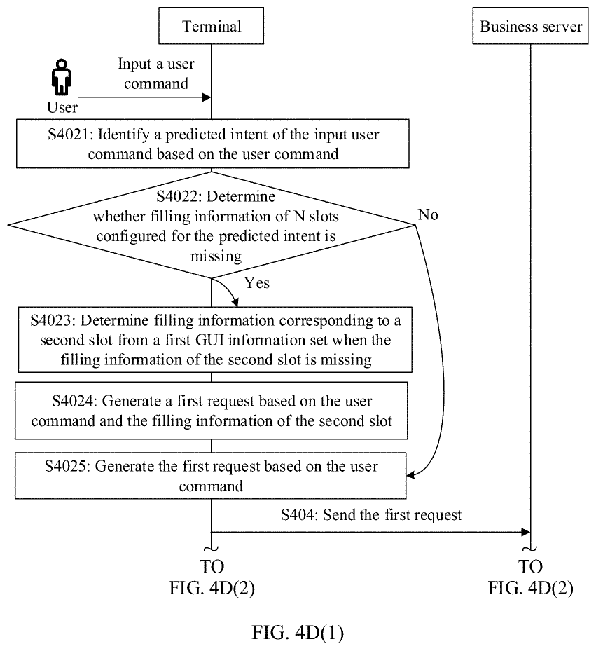

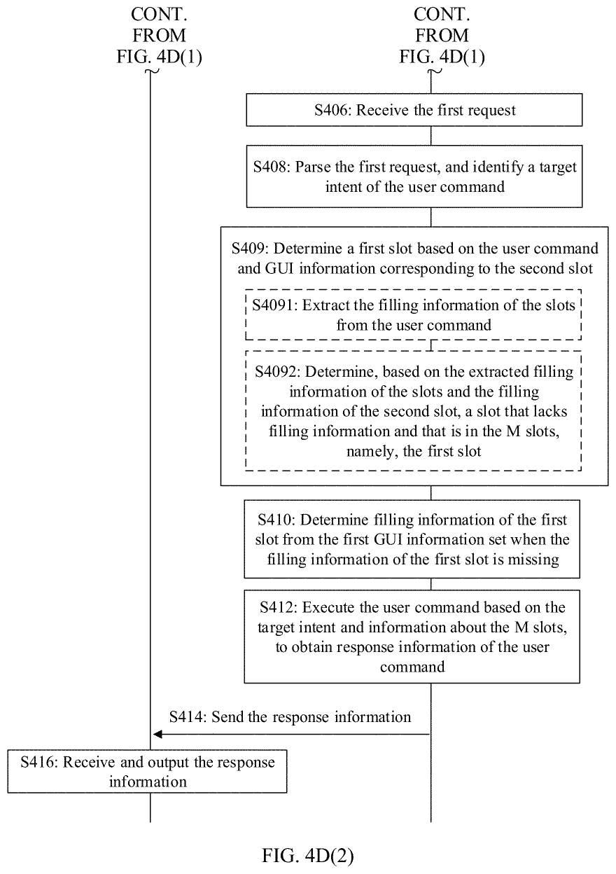

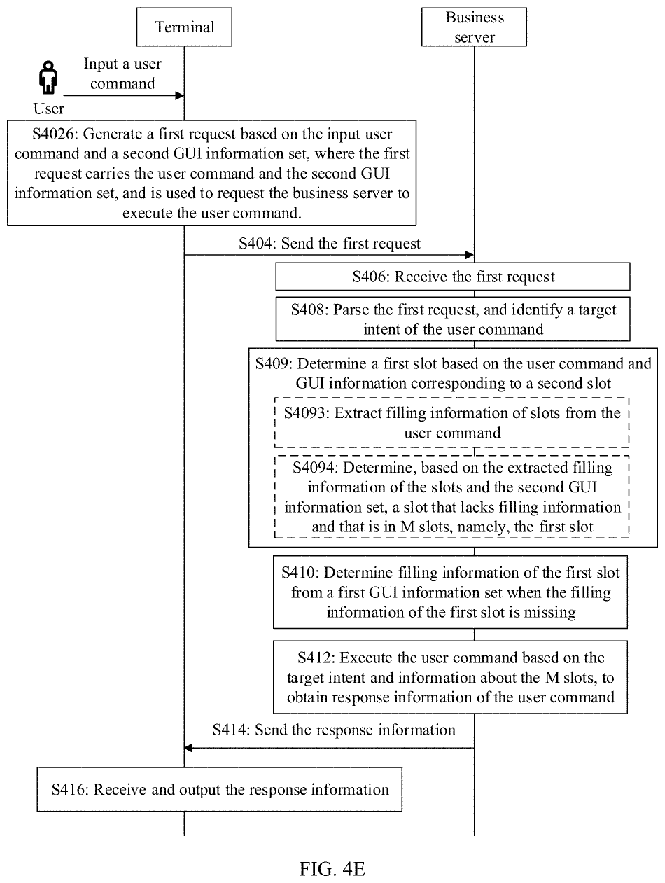

FIG. 4A is a schematic flowchart of a method for executing a user command. The method may be implemented by the system 30 shown in FIG. 3. The method may include but not limited to the following steps.

S402: A terminal generates a first request based on an input user command, where the first request is used to request a business server to execute the user command.

S404: The terminal sends the first request to the business server.

S406: The business server receives the first request.

S402 to S406 may include the following three implementations:

First Implementation:

A user may press a voice control on a VUI. In this case, the terminal detects the pressing operation for the voice control, and turns on a microphone to acquire voice input by the user. When the user no longer presses the voice control, the terminal detects a release operation for the voice control. A voice stream received in a time period in which the voice control is pressed is a user command in a voice format. The user may alternatively input a user command in a voice format by using the VUI interface. The terminal may generate the first request based on the user command in the voice format. In this case, the first request carries the user command in the voice format, and is used to request the business server to execute the user command. Further, the terminal may send the first request to the business server.

Second Implementation:

A user may input a voice stream by using a VUI interface, where the voice stream can be transmitted to a speech recognition server in real time. After receiving the voice stream, the speech recognition server may recognize the voice stream into text through automatic speech recognition (ASR), to obtain a user command in a text format. Further, the speech recognition server may send the user command in the text format to the business server. It should be understood that, in another implementation of this embodiment of this disclosure, the business server may also integrate a function of the speech recognition server. In this case, the speech recognition server and the business server may be a same device. For example, a speech recognition module in the business server may implement the function of the foregoing speech recognition server.

When the terminal sends the voice stream to the speech recognition server, the terminal may also send the first request to the business server, where the first request may carry indication information of the user command, to request the business server to execute the user command.

Third Implementation:

A user may enter text by using a GUI interface, and in this case, a user command in a text format is obtained. The terminal generates the first request based on the user command in the text format, and sends the first request to the server, where the first request carries the user command in the text format.

S408: The business server parses the first request, to identify a target intent of the user command.

In some embodiments of this disclosure, the first request carries the user command. In this case, after receiving the first request, the business server may parse the first request to obtain the user command. When the user command is text, the business server may identify an intent of the user command by using an intent identification algorithm to obtain the target intent. When the user command is voice, the user command is recognized as text through automatic speech recognition (ASR), and then the intent of the recognized text is identified by using an intent classifier to obtain the target intent.

In some other embodiments of this disclosure, the first request does not carry the user command. In this case, the user command is a voice stream, and the first request carries only indication information used to indicate to execute the user command. After receiving the voice stream, the speech recognition server recognizes the voice stream as text by using an ASR algorithm, to obtain a user command in a text format, and further, an intent of the user command in the text format is identified by using the intent classifier, to obtain the target intent.

In an implementation in which the business server identifies the target intent of the user command, the business server may configure the intent classifier and the like, to identify the target intent of the user command, obtain M slots configured for the target intent, and extract filling information of each slot from the user command, to obtain filling information of K slots, where K is a positive integer not greater than M.

In another implementation in which the business server identifies the target intent of the user command, the business server may request a natural language understanding (NLU) server to implement intent identification, slot filling, and the like for the user command. For example, the business server sends a first identification request to the NLU server, where the first identification request is used to request the NLU server to identify the intent of the user command. After receiving the first identification request, the NLU server inputs the user command to the intent classifier to obtain the target intent, obtains M slots configured for the target intent, and extracts filling information of each slot from the user command to obtain filling information of K slots, where K is a positive integer not greater than M; and further, the target intent, the M slots configured for the target intent, and the filling information of the K slots are sent to the business server.

To distinguish between intents of the user command, an initially identified intent of the user command is referred to as a predicted intent, and a finally identified intent of the user command is referred to as the target intent. It should be understood that the business server executes the user command based on the finally identified target intent and information about the plurality of slots configured for the target intent. In some embodiments of this disclosure, the predicted intent may be an intent of a user command that is identified by using an intent classifier of a coarse granularity, and the target intent is an intent of a user command that is identified by using an intent classifier of a fine granularity.

S410: The business server determines filling information of a first slot from a first GUI information set when filling information of the first slot is missing.

FIG. 4B(1) and FIG. 4B(2) are a schematic flowchart of a command execution method. The first implementation of S410 may include but not limited to steps S4101 to S4106.

S4101: The business server determines whether filling information of the M slots configured for the target intent is missing.

Usually, a slot is information required to convert the intent of the user command into an executable instruction. In actual application, one or more slots or no slot may be configured for one intent. It should be understood that, for an intent for which no slot needs to be configured, a case in which information about slots is missing does not occur. When no slot is configured for the target intent of the user command, the server may directly execute the target intent. When M slots are configured for the target intent of the user command, the server needs to further determine whether the filling information of the M slots configured for the target intent is missing, and if the filling information of the M slots configured for the target intent is missing, the server performs step S4102; and otherwise, the server performs S412.

In some embodiments, the server may store or obtain a correspondence between intents and slots. The following Table 1 describes the correspondence between intents and slots.

TABLE 1

| Intents | Slots | | |
|---|---|---|---|
| Air ticket booking | Departure | Landing place | Travel time |
| Select a hotel closest to | List of | Destination | |
| a destination from a | selected hotels | | |
| hotel list | | | |
| Play a song | Singer | Song name | |
| Distance from a current | Current hotel | Destination | |
| hotel to the destination | | | |
| . . . | . . . | . . . | . . . |

In some embodiments, the business server may determine the M slots corresponding to the target intent based on the correspondence between intents and slots, and further extract the filling information of the slots from the user command, for example, obtain the filling information of the K slots, where K is a positive integer not greater than M. A specific implementation of determining whether filling information of each slot is missing may be that the business server determines whether K is less than M, or whether the M slots include a slot that does not belong to the K slots. If K is less than M, or the M slots include a slot that does not belong to the K slots, the filling information of the M slots is missing, and the business server may perform S4102; and otherwise, the filling information of the M slots is not missing, and the business server may perform S412. One intent may correspond to one or more slots. Description is provided herein by using an example in which the target intent corresponds to M slots. It should be understood that, for different target intents, values of M may be different.

For example, text of the user command is “How far is this hotel from Huawei Building?”. In this case, the target intent is “distance from the current hotel to the destination”, filling information of the slot “current hotel” is missing, and filling information of the slot “destination” is “Huawei Building”.

In another example, the text of the user command is “Which one of these hotels is closest to Hongqiao Airport?”. In this case, the target intent is “select a hotel closest to a destination from a hotel list”, filling information of the slot “list of selected hotels” is missing, and filling information of the slot “destination” is “Hongqiao Airport”.

Usually, the user command may relate to problems of scenarios such as clothes, food, housing, and transportation. To find slots corresponding to an intent more quickly and facilitate the terminal to store the first GUI information set, in some other embodiments, the server may store or obtain a correspondence between scenarios, intents, and slots. The following Table 2 describes the correspondence between scenarios, intents, and slots.

TABLE 2

| Scenarios | Intents | Slots | | |
|---|---|---|---|---|
| Scenario | Air ticket booking | Departure | Landing | Travel |
| of air | | | place | time |
| ticket | Flight whose take-off | Flight List | Target | |
| booking | time is closest to target | | time | |
| | time in a flight list | | | |
| | . . . | . . . | . . . | . . . |
| Scenario | Select a hotel closest to | Hotel list | Destination | |
| of | a destination from a | | | |
| hotel | hotel list | | | |
| booking | Distance from a current | Current | Destination | |
| | hotel to the destination | hotel | | |
| | . . . | . . . | . . . | . . . |

The server may recognize a current scenario based on the user command, further determine the correspondence between intents and slots in the current scenario, further determine the M slots corresponding to the target intent, and further determine whether information about each slot is missing.

S4102: The business server generates a second request when the filling information of the first slot is missing, where the second request is used to request the filling information of the first slot from the terminal.

It should be understood that, the first slot is a slot that lacks information and that is in the M slots configured for the target intent, and may be one or more slots. This is not limited in this embodiment of this disclosure.

S4103: The business server sends the second request to the terminal.

S4104: The terminal receives the second request, and determines the filling information of the first slot from the first GUI information set.

After receiving the second request, the terminal parses the second request, and further responds to the second request. To be specific, the terminal may find GUI information corresponding to the first slot from the first GUI information set, and further determine the filling information of the first slot from the GUI information corresponding to the first slot. It should be understood that, in another implementation of S4104, the GUI information corresponding to the first slot in the first GUI information set is the filling information of the first slot. This is related to content of the GUI information corresponding to slots that is stored in the terminal.

For a specific implementation of the first GUI information set, refer to related descriptions in the foregoing data processing method and the GUI shown in FIG. 1A to FIG. 1E. Details are not described herein again.

S4105: The terminal sends the filling information of the first slot to the business server.

S4106: The business server receives the filling information of the first slot.

Similar to the first implementation of S410, in a second implementation of S410, the second request is replaced with a third request, where the third request is used to request the GUI information corresponding to the first slot from the terminal. In this case, the terminal may find the GUI information corresponding to the first slot from the first GUI information set, and the business server determines the filling information of the first slot from the GUI information corresponding to the first slot. For a specific implementation, refer to related descriptions in the embodiment shown in FIG. 4B(1) and FIG. 4B(2). Details are not described herein again.

In some embodiments, the filling information of the first slot and the GUI information corresponding to the first slot are referred to as first information, where the first information is used to determine the filling information of the first slot. For details, refer to related descriptions in the first implementation and the second implementation in S410. Details are not described herein again.

S412: The business server executes the user command based on the target intent and the filling information of the M slots, to obtain response information of the user command.

S414: The business server sends the response information to the terminal.

S416: The terminal receives and outputs the response information.

An implementation in which the terminal outputs the response information may be that the terminal displays the response information on a GUI interface and/or plays the response information by using an audio output apparatus, or the like.

In some embodiments, if the first slot includes a plurality of slots, for an implementation of determining whether the filling information of the M slots is missing and obtaining missing filling information of the slots, refer to the flowchart shown in FIG. 4C. An implementation of S410 to S420 may include but not limited to the following steps.

S01: The business server determines whether filling information of an ith slot in the M slots is missing, and if the filling information of the ith slot in the M slots is missing, the business server performs step S02, and otherwise, performs step S08, where i is an index of a slot in the M slots, and i is a positive integer less than M.

S02: The business server determines whether the filling information of the ith slot can be obtained from the first GUI information set, and if the filling information of the ith slot can be obtained from the first GUI information set, the business server performs step S03, and otherwise, performs step S08.

It should be understood that, the server may include a list, the list includes at least one intent and at least one slot corresponding to each intent, and filling information of the slot in the list can be obtained from the first GUI information set. The business server views whether the ith slot of the M slots configured for the target intent is in the list. If the ith slot of the M slots configured for the target intent is in the list, the filling information of the ith slot can be obtained from the first GUI information set, and otherwise, cannot be obtained from the first GUI information set.

S03: The business server generates a request Rᵢ based on the ith slot, where the request Rᵢ is used to request the filling information of the ith slot from the terminal.

S04: The business server sends the request Rᵢ to the terminal.

S05: The terminal receives the request Rᵢ, and determines the filling information of the ith slot from the first GUI information set.

S06: The terminal sends the filling information of the ith slot to the business server.

S07: The business server receives the filling information of the ith slot.

S08: The business server determines whether the filling information of the M slots is all obtained, or may determine whether i is equal to M; if the filling information of the M slots is all obtained, or i is equal to M, the business server ends the flow; and otherwise, i=i+1, and the business server repeatedly performs S03.

### Embodiment 2

A terminal may include an intent classifier of a coarse granularity, to predict a predicted intent of a user command, and the terminal sends possibly missing filling information of slots and the user command to a business server together, so that the business server can identify a target intent more accurately. Filling information of M slots configured for the target intent may be obtained from the user command and the possibly missing filling information of the slots at a high probability, to further reduce interactions between the business server and the terminal to provide the filling information of the slots, and user experience is better. FIG. 4D(1) and FIG. 4D(2) are a schematic flowchart of a command execution method according to an embodiment of this disclosure. The method may be implemented by the system 30 shown in FIG. 3. The method may include but not limited to some or all of the following steps.

S4021: The terminal identifies the predicted intent of the input user command based on the user command.

In this embodiment of this disclosure, an intent classifier in the terminal may be an intent classifier of a coarse granularity, and has low accuracy compared with an intent classifier in a server. The predicted intent is not a target intent that has relatively high accuracy and that is finally identified for the user command. Therefore, the intent of the user command that is identified by the terminal is referred to as the predicted intent herein. It should be noted that, in another embodiment of this disclosure, it may be considered that an identification result of the intent classifier in the terminal for the user command is relatively accurate, and may be used as the intent finally identified for the user command. Refer to related descriptions in Embodiment 5, and details are not described.

S4022: The terminal determines, based on the user command, whether filling information of N slots configured for the predicted intent is missing, where N is positive integer.

The terminal may store a correspondence between intents and slots, a correspondence between slots and GUI information, and the like. Further, the terminal may find the N slots corresponding to the predicted intent based on the correspondence between intents and slots. One intent may correspond to one or more slots. Description is provided herein by using an example in which the predicted intent corresponds to N slots. It should be understood that, for different predicted intents, values of N may be different.

It should be understood that, no slot may need to be configured for the predicted intent of the user command. When no slot is configured for the predicted intent or information about the N slots configured for the predicted intent is not missing, the terminal may generate a first request based on the user command, and performs S404.

It should be understood that, the terminal may store or obtain the correspondence between intents and slots. For example, the terminal may download the correspondence between intents and slots from the execution server, and store the correspondence. Further, the terminal may extract filling information of the slots from the user command (this process is also referred to as slot filling), and further determine, based on the extracted filling information of the slots, whether the information about the N slots is all present. If the information about the N slots is all present, the filling information of the slots is not missing, and the terminal may generate the first request based on the user command, and perform S404, and otherwise, the terminal may perform S4023.

S4023: The terminal determines filling information of a second slot from a first GUI information set when filling information of the second slot is missing.

The second slot is a slot that lacks filling information and that is in the N slots, may be one or more slots, or may be a necessary slot in missing slots. When the filling information of the second slot is missing, the terminal may find GUI information corresponding to the second slot from the first GUI information set, and further determine the filling information of the second slot from the GUI information corresponding to the second slot.

For example, when a missing slot is “list of selected hotels”, the terminal first finds GUI information corresponding to the slot “list of selected hotels” from the first GUI information set. In an implementation, the GUI information corresponding to the “list of selected hotels” includes hotel information corresponding to each selected control, for example, a hotel identifier, an address, and a contact number. In this case, the terminal may determine a hotel identifier, for example, a name corresponding to each selected control from the GUI information corresponding to the “list of selected hotels”, and further obtain the filling information of the second slot.

In another implementation of S4023, the GUI information corresponding to the second slot in the first GUI information set is the filling information of the second slot. This is related to content of the GUI information corresponding to slots that is stored in the terminal.

S4024: Generate the first request based on the user command and the filling information of the second slot, where the first request carries the user command and the filling information of the second slot, and is used to request the business server to execute the user command.

S4025: Generate the first request based on the user command, where the first request carries the user command, and is used to request the business server to execute the user command.

It should be understood that, S4021 to S4025 are an implementation of S402.

After S4024, S404 to S408 may be performed. Refer to a related description in the foregoing embodiment for a specific implementation. Details are not described herein again.

After S408 and before S410, the method may further include:

S409: The business server determines a first slot based on the user command and the GUI information corresponding to the second slot, and a specific implementation may include S4091 and S4092, namely:

S4091: The business server may extract the filling information of the slots from the user command.

S4092: Determine, based on the extracted filling information of the slots and the filling information of the second slot, a slot that lacks filling information and that is in the M slots, namely, the first slot. In other words, the first slot is a slot, other than the slots whose filling information is extracted and the second slot, in the M slots.

Step S410 to step S416 may also be performed after S409. Refer to related descriptions in Embodiment 1 for a specific implementation. Details are not described herein again.

### Embodiment 3

To reduce the quantity of times of interactions between a terminal and a business server, and improve interaction efficiency, the terminal may send GUI information corresponding to a slot used at a high frequency and a user command to the business server together, so that the business server can obtain, from the received GUI information corresponding to the slot and the received user command, filling information of M slots configured for a target intent of the user command, to reduce the quantity of times of interactions between the business server and the terminal. FIG. 4E is a schematic flowchart of another command execution method according to an embodiment of this disclosure. The method may be implemented by the system shown in FIG. 3. The method may include but not limited to some or all of the following steps.

S4026: Generate a first request based on an input user command and a second GUI information set, where the first request carries the user command and the second GUI information set, and is used to request a business server to execute the user command.

In an implementation, the second GUI information set may be a set of GUI information respectively corresponding to a plurality of slots. The plurality of slots may be slots configured for each of all intents in a current scenario.

In another implementation, in a specific scenario, filling information of some slots is used at a relatively high frequency to execute the user command. For example, in a scenario of air ticket booking, a set of intents may be included to identify an intent of the user command in this scenario. Slots such as “list of airports selected by a user” and “currently displayed air tickets” are slots configured for high-frequency user commands such as “How far is the airport of this air ticket”, “Which one of these air tickets takes shortest time”, and “which one of these air tickets has a lowest price”. These slots are used at a very high frequency in the scenario of air ticket booking. To reduce communication time, GUI information corresponding to the high-frequency slot may be encapsulated into the first request for transmission to the business server, to reduce the quantity of times of interactions between the terminal and the business server, to execute the user command more efficiently. In this case, the plurality of slots may be slots used at a high frequency in the current scenario. A frequency of a slot S may be obtained through statistical collection based on historical user commands, or a quantity of intents that are of all the intents in the current scenario and for which the slot S is configured may be used to represent the frequency at which the slot S is used, or the slot S may be considered as a slot used at a high frequency during program development. This is not limited herein.

S4026 is an implementation of S402 in Embodiment 1. After S4026, S404 to S408 may be performed. In this case, after S408 and before S410, the method may further include:

S409: The business server determines a first slot based on the user command and GUI information corresponding to a second slot, and a specific implementation may include S4093 and S4094, namely:

S4093: The business server may extract filling information of slots from the user command.

S4094: Determine, based on the extracted filling information of the slots and the second GUI information set, a slot that lacks filling information among the M slots, namely, the first slot. In other words, the first slot is a slot, other than the extracted slots and the slots included in the second GUI information set, among the M slots.

Step S410 to step S416 may also be performed after S409. Refer to related descriptions in Embodiment 1 for a specific implementation. Details are not described herein again.

### Embodiment 4

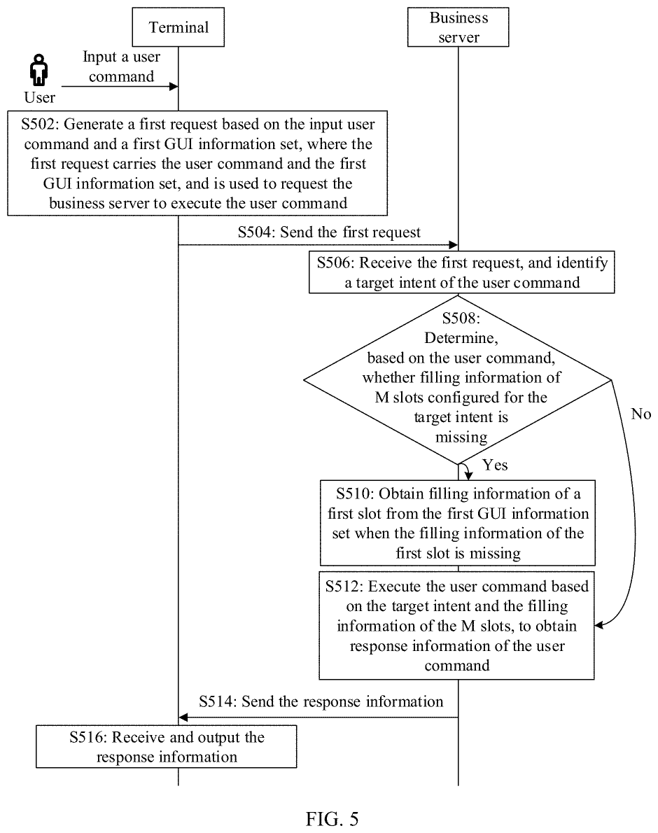

To reduce the quantity of times of interactions between a terminal and a business server, and improve interaction efficiency, the terminal may send a stored first GUI information set completely to the business server. FIG. 5 is a schematic flowchart of another command execution method according to an embodiment of this disclosure. The method may be implemented by the system shown in FIG. 3. The method may include but not limited to some or all of the following steps.

S502: Generate a first request based on an input user command and a first GUI information set, where the first request carries the user command and the first GUI information set, and is used to request a business server to execute the user command.

The first GUI information set may include a set of GUI information corresponding to a plurality of slots that is stored in the terminal. The plurality of slots may be slots configured for each of all intents in a current scenario.

It should be understood that, S502 is an implementation of S402 in Embodiment 1.

S504: The terminal sends the first request to the business server.

S506: The business server receives the first request, to identify a target intent of the user command.

It should be understood that, after receiving the first request, the business server may identify the target intent of the user command, find M slots configured for the target intent, and extract filling information of K slots from the user command. Refer to related descriptions in Embodiment 1 for a specific implementation. Details are not described herein again.

S508: The business server determines, based on the user command, whether filling information of the M slots configured for the target intent is missing, where herein the business server determines whether K is less than M, or whether the M slots include a slot that does not belong to the K slots; if K is less than M, or the M slots include a slot that does not belong to the K slots, the filling information of the M slots is missing, and the business server may perform S510; and otherwise, the filling information of the M slots is not missing, and the business server may perform S512.

S510: The command execution server obtains filling information of a first slot from the first GUI information set when filling information of the first slot is missing.

The first slot is a slot that lacks filling information among the M slots, may be one or more slots, or may be a necessary slot among the missing slots. When the filling information of the first slot is missing, the terminal may find GUI information corresponding to the first slot from the first GUI information set, and further determine the filling information of the first slot from the GUI information corresponding to the first slot.

In another implementation of S510, the GUI information corresponding to the first slot in the first GUI information set is the filling information of the first slot. This is related to content of the GUI information corresponding to slots that is stored in the terminal.

It should be understood that, S506 to S510 are an implementation of S410 in Embodiment 1.

S512: Execute the user command based on the target intent and the filling information of the M slots, to obtain response information of the user command.

It should be understood that, when no slot needs to be configured for the target intent, the business server may not perform steps S508 to S512, and directly execute the user command based on the target intent, to further obtain the response information of the user command.

S514: The business server sends the response information to the terminal.

S516: The terminal receives and outputs the response information.

For an implementation of S512 to S516, refer to related descriptions in steps S412 to S416 in Embodiment 1, and details are not described herein again.

### Embodiment 5

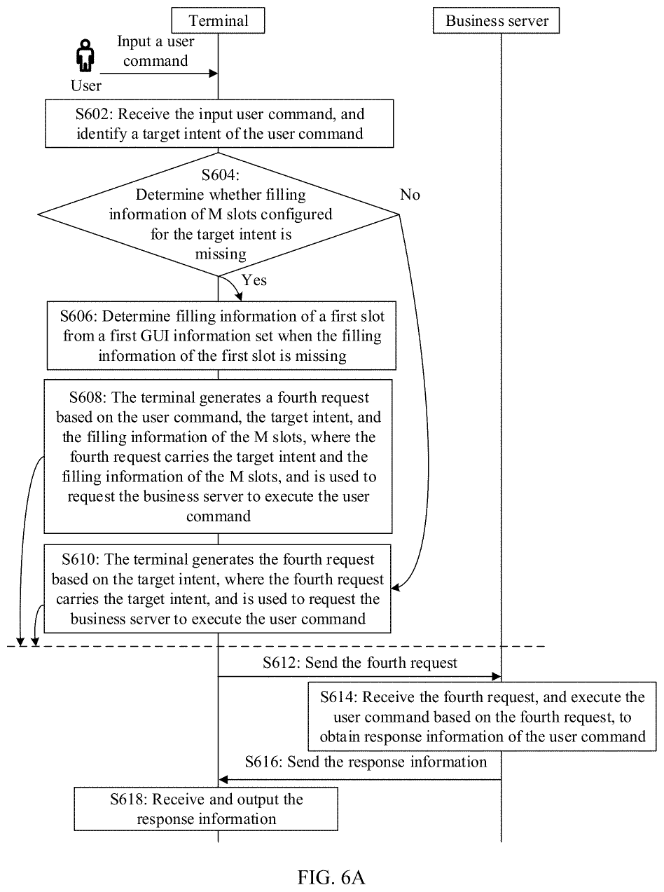

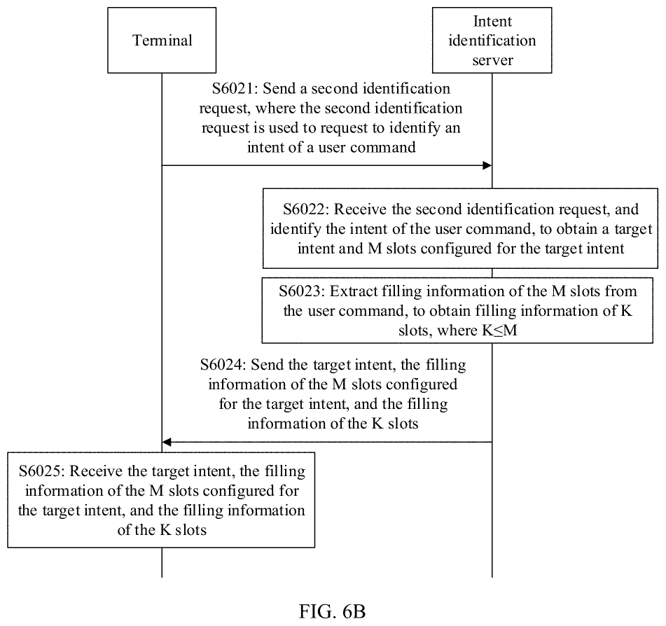

A terminal may include an intent classifier, to further identify an intent of a user command, and may obtain, based on the user command and a stored first GUI information set, filling information of all slots configured for the intent of the user command. Further, a business server may directly execute the user command based on the identified intent and the filling information of the all the slots configured for the intent, to further avoid interactions between the business server and the terminal to provide the filling information of the slots, and user experience is better. FIG. 6A is a schematic flowchart of another command execution method according to an embodiment of this disclosure. The method may be implemented by the system shown in FIG. 3. The method may include but not limited to some or all of the following steps.

S602: The terminal receives an input user command, and identifies a target intent of the user command.

In this embodiment of this disclosure, an intent classifier in the terminal may be a classifier with high accuracy. The target intent is an intent that has relatively high accuracy and that is finally identified for the user command. Therefore, a business server no longer identifies the intent of the user command herein.

In an implementation of S602, the terminal may identify the target intent of the user command by itself. In this case, the terminal may identify the intent of the user command by using the intent classifier, to obtain the target intent, and further obtain, based on a stored correspondence between intents and slots, M slots configured for the target intent; and further, the terminal may extract filling information of the M slots from the user command, to obtain filling information of K slots, where K is a positive integer not greater than M. It should be understood that, the filling information of the M slots may be completely or incompletely extracted from the user command. One intent may correspond to one or more slots. Description is provided herein by using an example in which the target intent corresponds to M slots. It should be understood that, for different target intents, values of M may be different.

An implementation in which the terminal identifies the intent of the user command is the same as an implementation in which the business server identifies the intent of the user command in Embodiment 1. For a specific implementation, refer to related descriptions about identifying the intent of the user command in Embodiment 1. Details are not described herein again.

In an implementation of S602, the terminal may alternatively request a natural language understanding (NLU) server to identify the target intent of the user command. As shown in FIG. 6B, an implementation in which the terminal requests the NLU server to identify the target intent of the user command may include but not limited to the following steps.

S6021: The terminal sends a second identification request to the NLU server, where the second identification request is used to request to identify the intent of the user command.

S6022: The NLU server receives the second identification request, and identifies the intent of the user command, to obtain the target intent and the M slots configured for the target intent.

After identifying the target intent of the user command, the NLU server may obtain or store the correspondence between intents and slots, and may further find the M slots corresponding to the target intent based on the correspondence between intents and slots.

S6023: The NLU server extracts the filling information of the M slots from the user command, to obtain the filling information of the K slots, where K is a positive integer not greater than M. It should be understood that, the filling information of the M slots may be completely or incompletely extracted from the user command.

S6024: Send the target intent, the filling information of the M slots configured for the target intent, and the filling information of the K slots to the terminal.

S6025: The terminal receives the target intent, the filling information of the M slots configured for the target intent, and the filling information of the K slots.

In another implementation of this embodiment of this disclosure, S6023 may alternatively be performed by the terminal. In this case, after S6022, the NLU server sends the target intent and the M slots configured for the target intent to the terminal, and after receiving the target intent and the M slots configured for the target intent, the terminal performs S6023, and further obtains the target intent, the filling information of the M slots configured for the target intent, and the filling information of the K slots.

It should be understood that, no slot may need to be configured for the target intent of the user command, and when no slot is configured for the target intent, the NLU server may perform S612.

S604: The terminal determines whether the filling information of the M slots configured for the target intent is missing, where M is positive integer.

Specifically, the terminal may determine whether K is less than M, whether the M slots include a slot that does not belong to the K slots, or the like. If K is less than M, or the M slots include a slot that does not belong to the K slots, the filling information of the M slots is missing, and the terminal performs S606; and otherwise, the filling information of the M slots is not missing, and the terminal performs S608.

S606: Determine filling information of a first slot from the first GUI information set when filling information of the first slot is missing.

The first slot is a slot that lacks filling information among the M slots, may be one or more slots, or may be a necessary slot among the missing slots. When the filling information of the first slot is missing, the terminal may find GUI information corresponding to the first slot from the first GUI information set, and further determine the filling information of the first slot from the GUI information corresponding to the first slot.

In another implementation of S606, the GUI information corresponding to the first slot in the first GUI information set is the filling information of the first slot. This is related to content of the GUI information corresponding to slots that is stored in the terminal.

It may be understood that, in Embodiment 5, steps S408 and S410 in Embodiment 1 are performed by the terminal. Refer to related descriptions in S408 and S410 in Embodiment 1 for a specific implementation. Details are not described herein again.

S608: The terminal generates a fourth request based on the user command, the target intent, and the filling information of the M slots, where the fourth request carries the target intent and the filling information of the M slots, and is used to request the business server to execute the user command.

S610: The terminal generates the fourth request based on the target intent, where the fourth request carries the target intent, and is used to request the business server to execute the user command.

S612: The terminal sends the fourth request to the execution server.

S614: The business server receives the fourth request, and executes the user command based on the fourth request, to obtain response information of the user command.

After receiving the fourth request sent in step S608, the business server may execute the user command based on the target intent and the filling information of the M slots, to obtain response information of the user command.

After receiving the fourth request sent in step S610, the business server may execute the user command based on the target intent, to obtain the response information of the user command.

S616: The business server sends the response information to the terminal.

S618: The terminal receives and outputs the response information.

Refer to related descriptions in Embodiment 1 for a specific implementation of S614 to S618. Details are not described herein again.

The foregoing describes in detail the methods in the embodiments of the present disclosure, and the following provides apparatuses in the embodiments of the present disclosure.

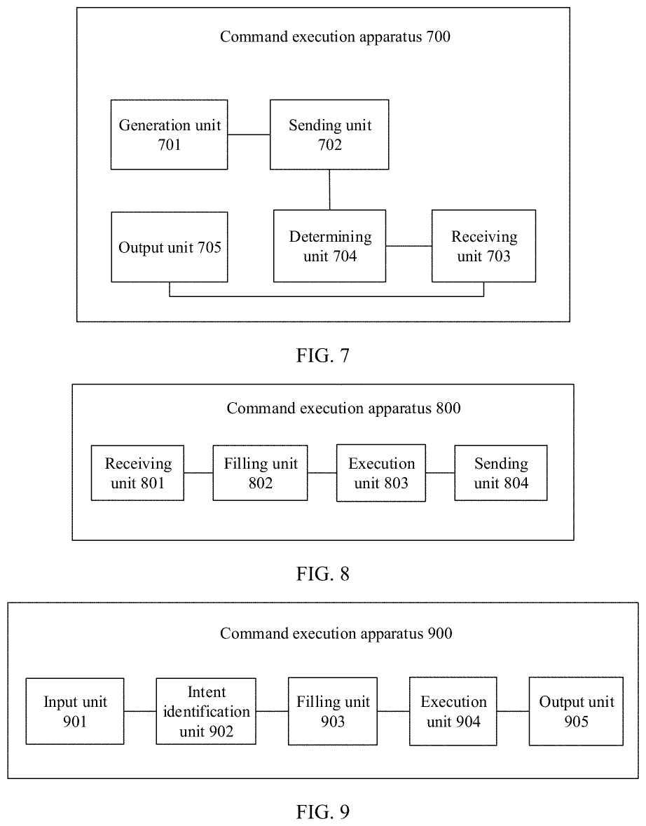

FIG. 7 is a schematic diagram of a structure of a command execution apparatus according to an embodiment of the present disclosure. The apparatus 700 is used in a terminal, and may include but not limited to the following functional units:

a generation unit 701, configured to generate a first request based on an input user command, where the first request is used to request a server to execute the user command;

a sending unit 702, configured to send the first request to the server;

a receiving unit 703, configured to receive a second request sent by the server, where the second request is used to request first information from the terminal, and the first information is used to determine filling information of a first slot; and

a determining unit 704, configured to determine the first information in a first GUI information set based on the second request; where

the sending unit 702, further configured to send the first information to the server, where the first slot is a slot that lacks filling information among the M slots configured for a target intent of the user command, M is a positive integer, the first GUI information set includes a correspondence between slots and GUI information, and the target intent and filling information of the M slots are used to execute the user command.

Optionally, the receiving unit 703 is further configured to receive response information sent by the server for the user command. The apparatus 700 may further include an output unit 705, and the output unit 705 is configured to output the response information.

Optionally, the first information is the filling information of the first slot or GUI information corresponding to the first slot.

Refer to related descriptions in Embodiment 1 for specific implementation of the foregoing units. Details are not described herein again.

In a possible implementation, the apparatus 700 further includes:

a storage unit, configured to update or store graphical user interface (GUI) information corresponding to a first control when a user operation for the first control is detected on a GUI, where the GUI is a user interface displayed on the terminal.

In a possible implementation, the generation unit 701 is configured to: identify a predicted intent of the input user command; obtain GUI information corresponding to a second slot from the first GUI information set when filling information of the second slot is missing, where the second slot is a slot that lacks filling information among the N slots configured for the predicted intent of the user command, and N is a positive integer; and generate the first request based on the user command and the GUI information corresponding to the second slot, where the first request carries the GUI information corresponding to the second slot, so that after receiving the first request, the server determines the first slot based on the user command and the GUI information corresponding to the second slot.

Refer to related descriptions in Embodiment 2 for specific implementation of the foregoing units. Details are not described herein again.

In a possible implementation, the generation unit 701 is configured to: generate a first request based on an input user command and a second GUI information set, where the first request carries the second GUI information set.

Refer to related descriptions in Embodiment 3 for specific implementation of the foregoing units. Details are not described herein again.

In a possible implementation, the generation unit 701 is configured to: generate a first request based on an input user command and a first GUI information set, where the first request carries the first GUI information set.

Refer to related descriptions in Embodiment 4 for specific implementation of the foregoing units. Details are not described herein again.

In a possible implementation, the sending unit 702 is further configured to: send graphical user interface (GUI) information corresponding to a first control to the server when a user operation for the first control is detected on a GUI, where the GUI is a user interface displayed on the terminal.

Refer to related descriptions in Embodiment 4 for specific implementation of the foregoing units. Details are not described herein again.

FIG. 8 is a schematic diagram of a structure of a command execution apparatus according to an embodiment of the present disclosure. The apparatus 800 is used in a server and may include but not limited to the following functional units:

a receiving unit 801, configured to receive a first request sent by a terminal, where the first request is used to request the server to execute a user command;

a filling unit 802, configured to determine filling information of a first slot from a first GUI information set when the filling information of the first slot is missing, where the first slot is a slot that lacks filling information among the M slots configured for a target intent of the user command, M is a positive integer, and the first GUI information set includes a correspondence between slots and GUI information; and

an execution unit 803, configured to execute the user command based on the target intent of the user command and filling information of the slots configured for the target intent.

Optionally, the execution unit 803 executes the user command to obtain response information of the user command. The apparatus 800 may further include a sending unit 804, and the sending unit 804 is configured to send the response information to the terminal.

Refer to related descriptions in Embodiment 1 for specific implementation of the foregoing units. Details are not described herein again.

In a possible implementation, the first GUI information set includes GUI information corresponding to a first control, the GUI information corresponding to the first control is stored or updated by the terminal when the terminal detects a user operation for the first control on a graphical user interface (GUI), where the GUI is a user interface displayed on the terminal.

In a possible implementation, the sending unit 804 is further configured to send a second request to the terminal when the filling information of the first slot is missing, where the second request is used to request the filling information of the first slot from the terminal; and

the receiving unit 801 is further configured to receive the filling information of the first slot from the terminal, where the filling information of the first slot is determined by the terminal from the first GUI information set.

Refer to related descriptions in Embodiment 1 for specific implementation of the foregoing units. Details are not described herein again.

In a possible implementation, the determining filling information of a first slot from a first GUI information set when the filling information of the first slot is missing includes:

the sending unit 804 is further configured to send a third request to the terminal when the filling information of the first slot is missing, where the third request is used to request GUI information corresponding to the first slot from the terminal;

the receiving unit 801 is further configured to receive the GUI information corresponding to the first slot from the terminal, where the GUI information corresponding to the first slot is determined by the terminal from the first GUI information set; and

the filling unit 802 is configured to determine the filling information of the first slot based on the GUI information corresponding to the first slot.

Refer to related descriptions in Embodiment 1 for specific implementation of the foregoing units. Details are not described herein again.

In a possible implementation, the first request carries GUI information corresponding to a second slot. The apparatus 800 further includes: a first determining unit, configured to: after the receiving unit receives the first request sent by the terminal and before the filling unit determines the filling information of the first slot from the first GUI information set when the filling information of the first slot is missing, determine the first slot based on the user command and the GUI information corresponding to the second slot, where the second slot is a slot that lacks filling information among the N slots configured for a predicted intent of the user command, N is a positive integer, and the predicted intent is an intent of the user command that is identified by the terminal.

Refer to related descriptions in Embodiment 2 for specific implementation of the foregoing units. Details are not described herein again.

In a possible implementation, the first request carries a second GUI information set, and the apparatus 800 further includes:

a second determining unit, configured to: after the receiving unit receives the first request sent by the terminal and before the filling unit determines the filling information of the first slot from the first GUI information set when the filling information of the first slot is missing, determine the first slot based on the user command and the second GUI information set.

Refer to related descriptions in Embodiment 3 for specific implementation of the foregoing units. Details are not described herein again.

In a possible implementation, the first request carries the first GUI information set.

In a possible implementation, the receiving unit 801 is further configured to receive the GUI information sent by the terminal and corresponding to the first control, and

the apparatus further includes a storage unit, configured to update or store the GUI information corresponding to the first control, where the first control is a control on the graphical user interface (GUI) of the terminal.

Optionally, the GUI information corresponding to the first control is the GUI information that corresponds to the first control on the graphical user interface (GUI) and that is obtained by the terminal when the terminal detects a user operation for the first control, where the GUI is a user interface displayed on the terminal.

Refer to related descriptions in Embodiment 4 for specific implementation of the foregoing units. Details are not described herein again.

FIG. 9 is a schematic diagram of a structure of a command execution apparatus according to an embodiment of the present disclosure. The apparatus 900 is used in a terminal, and may include but not limited to the following functional units:

an input unit 901, configured to receive an input user command;

an intent identification unit 902, configured to identify a target intent of the user command after the input unit 901 receives the input user command;

a filling unit 903, configured to determine filling information of a first slot from a first GUI information set when the filling information of the first slot is missing, where the first slot is a slot that lacks filling information among the M slots configured for the target intent, M is a positive integer, and the first GUI information set includes a correspondence between slots and GUI information;

an execution unit 904, configured to execute the user command based on the target intent and filling information of the M slots, to obtain response information of the user command; and

an output unit 905, configured to output the response information.

Optionally, the execution unit 904 is configured to: generate a fourth request based on the target intent and the filling information of the M slots; and send the fourth request to the server, where the fourth request is used to request the server to execute the target intent based on the target intent and the filling information of the M slots.

Refer to related descriptions in Embodiment 5 for specific implementation of the foregoing units. Details are not described herein again.

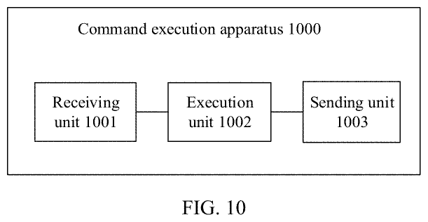

FIG. 10 is a schematic diagram of a structure of a command execution apparatus according to an embodiment of the present disclosure. The apparatus 1000 is used in a server, and may include but not limited to the following functional units:

a receiving unit 1001, configured to receive a fourth request sent by a terminal, where the fourth request is used to request to execute a target intent of a user command, the fourth request carries the target intent and filling information of M slots configured for the target intent, the filling information of the M slots includes filling information of a first slot, the filling information of the first slot is determined by the terminal based on a first GUI information set, M is a positive integer, and the first GUI information set includes a correspondence between slots and GUI information;

an execution unit 1002, configured to execute the target intent based on the target intent and the filling information of the M slots, to obtain response information; and

a sending unit 1003, configured to send the response information to the terminal.

Refer to related descriptions in Embodiment 5 for specific implementation of the foregoing units. Details are not described herein again.

It should be noted that, the apparatus 700 and the apparatus 900 may be the terminal that displays FIG. 1A to FIG. 1E, or may be the terminal in the scenario shown in FIG. 2A and FIG. 2B, or may be the terminal 31 in the system 30 shown in FIG. 3. The apparatus 800 and the apparatus 1000 may be the first server and the third server in the scenario shown in FIG. 2A and FIG. 2B, or may be the business server 32 in the system 30 shown in FIG. 3.

The following describes an example terminal 1100 provided in an embodiment of this disclosure. The terminal 1100 may be implemented as the terminal mentioned in any one of Embodiment 1 to Embodiment 5, or may be the terminal configured to display FIG. 1A to FIG. 1E, or may be the terminal in the scenario shown in FIG. 2A and FIG. 2B, or may be the terminal 31 in the system 30 shown in FIG. 3. The terminal 1100 with limited processing resources, for example, a mobile phone or a tablet computer, may separately request a server with a strong processing function, such as a business server, a speech recognition server, or a natural language processing server to execute a user command and identify text of the user command, and the terminal 1100 may alternatively separately execute the user command.

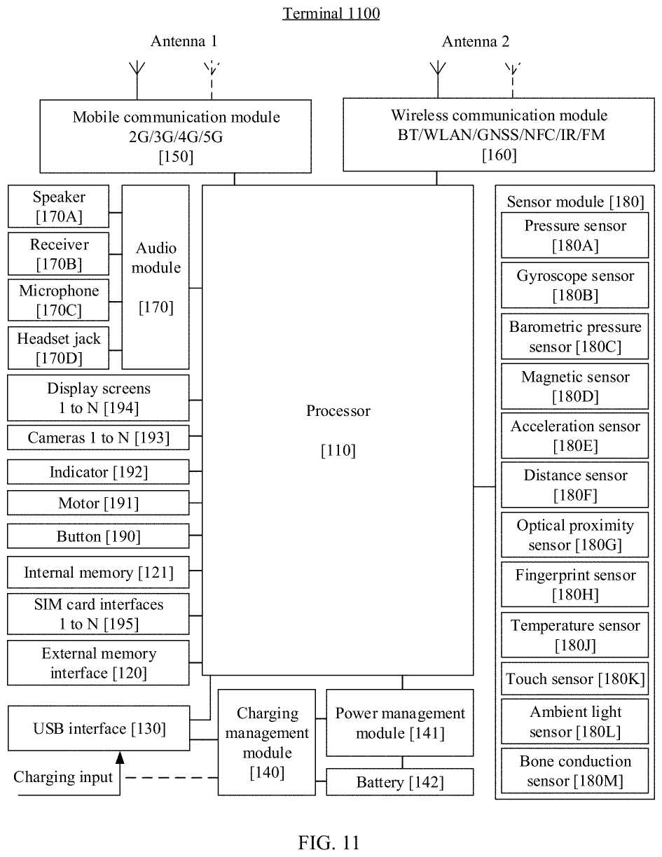

FIG. 11 is a schematic diagram of the structure of the terminal 1100.

The terminal 1100 may include a processor 110, an external memory interface 120, an internal memory 121, a universal serial bus (USB) interface 130, a charging management module 140, a power management module 141, a battery 142, an antenna 1, an antenna 2, a mobile communication module 150, a wireless communication module 160, an audio module 170, a speaker 170A, a receiver 170B, a microphone 170C, a headset jack 170D, a sensor module 180, a button 190, a motor 191, an indicator 192, cameras 193, display screens 194, a subscriber identity module (SIM) card interface 195, and the like. The sensor module 180 may include a pressure sensor 180A, a gyroscope sensor 180B, a barometric pressure sensor 180C, a magnetic sensor 180D, an acceleration sensor 180E, a distance sensor 180F, an optical proximity sensor 180G, a fingerprint sensor 180H, a temperature sensor 180J, a touch sensor 180K, an ambient light sensor 180L, a bone conduction sensor 180M, and the like.

It can be understood that the structure shown in this embodiment of the present disclosure does not constitute a specific limitation on the terminal 1100. In some other embodiments of this disclosure, the terminal 1100 may include more or fewer components than those shown in the figure, or combine some components, or split some components, or have different component arrangements. The components shown in the figure may be implemented through hardware, software, or a combination of software and hardware.

The processor 110 may include one or more processing units. For example, the processor 110 may include an application processor (AP), a modem processor, a graphics processing unit (GPU), an image signal processor (ISP), a controller, a memory, a video codec, a digital signal processor (DSP), a baseband processor, a neural-network processing unit (NPU), and/or the like. Different processing units may be independent components, or may be integrated into one or more processors. In some embodiments, the terminal 1100 may alternatively include one or more processors 110.

The controller may be a nerve center and a command center of the terminal 1100. The controller may generate an operation control signal based on instruction operation code and a time sequence signal, to complete control of instruction fetching and instruction execution.

The memory may be further disposed in the processor 110, and is configured to store instructions and data. In some embodiments, the memory in the processor 110 is a cache memory. The memory may store instructions or data just used or cyclically used by the processor 110. If the processor 110 needs to use the instructions or the data again, the processor 110 may directly invoke the instructions or the data from the memory, to avoid repeated access and reduce waiting time of the processor 110, thereby improving system efficiency of the terminal 1100.

In some embodiments, the processor 110 may include one or more interfaces. The interface may include an inter-integrated circuit (I2C) interface, an inter-integrated circuit sound (I2S) interface, a pulse code modulation (PCM) interface, a universal asynchronous receiver/transmitter (UART) interface, a mobile industry processor interface (MIPI), a general-purpose input/output (GPIO) interface, a subscriber identity module (SIM) interface, a universal serial bus (USB) interface, and/or the like.

The I2C interface is a two-way synchronization serial bus, and includes one serial data line (SDA) and one serial clock line (SCL). In some embodiments, the processor 110 may include a plurality of groups of I2C buses. The processor 110 may be separately coupled to the touch sensor 180K, a charger, a flashlight, the camera 193, and the like through different I2C bus interfaces. For example, the processor 110 may be coupled to the touch sensor 180K through an I2C interface, so that the processor 110 communicates with the touch sensor 180K through the I2C bus interface, to implement a touch function of the terminal 1100.

The I2S interface may be configured to perform audio communication. In some embodiments, the processor 110 may include a plurality of groups of I2S buses. The processor 110 may be coupled to the audio module 170 through the I2S bus, to implement communication between the processor 110 and the audio module 170. In some embodiments, the audio module 170 may transmit an audio signal to the wireless communication module 160 through the I2S interface, to implement a function of answering a call by using a Bluetooth headset.

The PCM interface may also be configured to: perform audio communication, and sample, quantize, and code an analog signal. In some embodiments, the audio module 170 may be coupled to the wireless communication module 160 through a PCM bus interface. In some embodiments, the audio module 170 may alternatively transmit an audio signal to the wireless communication module 160 through the PCM interface, to implement a function of answering a call by using the Bluetooth headset. Both the I2S interface and the PCM interface may be configured to perform audio communication.

The UART interface is a universal serial data bus, and is configured to perform asynchronous communication. The bus may be a two-way communication bus, and converts to-be-transmitted data between serial communication and parallel communication. In some embodiments, the UART interface is usually configured to connect the processor 110 to the wireless communication module 160. For example, the processor 110 communicates with a Bluetooth module in the wireless communication module 160 through the UART interface, to implement a Bluetooth function. In some embodiments, the audio module 170 may transmit an audio signal to the wireless communication module 160 through the UART interface, to implement a function of playing music by using the Bluetooth headset.

The MIPI interface may be configured to connect the processor 110 to a peripheral component such as the display screen 194 or the camera 193. The MIPI interface includes a camera serial interface (CSI), a display serial interface (DSI), or the like. In some embodiments, the processor 110 and the camera 193 communicate with each other through the CSI interface, to implement a photographing function of the terminal 1100. The processor 110 and the display screen 194 communicate with each other through the DSI interface, to implement a display function of the terminal 1100.

The GPIO interface may be configured through software. The GPIO interface may be configured as a control signal, or may be configured as a data signal. In some embodiments, the GPIO interface may be configured to connect the processor 110 to the camera 193, the display screen 194, the wireless communication module 160, the audio module 170, the sensor module 180, or the like. The GPIO interface may be further configured as the I2C interface, the I2S interface, the UART interface, the MIPI interface, or the like.

The USB interface 130 is an interface that conforms to a USB standard specification, and may be a mini USB interface, a micro USB interface, a USB Type C interface, or the like. The USB interface 130 may be configured to connect to a charger to charge the terminal 1100, may also be used for data transmission between the terminal 1100 and a peripheral device, and may also be configured to connect to a headset to play audio by using the headset. Alternatively, the interface may be further configured to connect to another electronic device, for example, an AR device.

It can be understood that an interface connection relationship between the modules shown in this embodiment of the present disclosure is merely an example for description, and does not constitute a limitation on the structure of the terminal 1100. In some other embodiments, alternatively, the terminal 1100 may use interface connection manners different from those in this embodiment or use a combination of a plurality of interface connection manners.

The charging management module 140 is configured to receive a charging input from the charger. The charger may be a wireless charger or a wired charger. In some embodiments of wired charging, the charging management module 140 may receive a charging input of the wired charger through the USB interface 130. In some embodiments of wireless charging, the charging management module 140 may receive a wireless charging input through a wireless charging coil of the terminal 1100. The charging management module 140 may further supply power to the electronic device by using the power management module 141 while charging the battery 142.

The power management module 141 is configured to connect to the battery 142, the charging management module 140, and the processor 110. The power management module 141 receives an input from the battery 142 and/or the charging management module 140, and supplies power to the processor 110, the internal memory 121, an external memory, the display screen 194, the camera 193, the wireless communication module 160, and the like. The power management module 141 may be further configured to monitor parameters such as a battery capacity, a quantity of battery cycles, and a battery health status (electric leakage or impedance). In some other embodiments, the power management module 141 may alternatively be disposed in the processor 110. In some other embodiments, the power management module 141 and the charging management module 140 may alternatively be disposed in a same device.

A wireless communication function of the terminal 1100 may be implemented by using the antenna 1, the antenna 2, the mobile communication module 150, the wireless communication module 160, the modem processor, the baseband processor, and the like.

The antenna 1 and the antenna 2 are configured to transmit and receive electromagnetic wave signals. Each antenna in the terminal 1100 may be configured to cover one or more communication bands. Different antennas may be further multiplexed, to improve antenna utilization. For example, the antenna 1 may be multiplexed as a diversity antenna in a wireless local area network. In some other embodiments, an antenna may be used in combination with a tuning switch.

The mobile communication module 150 may provide a solution, applied to the terminal 1100, to wireless communication including 2G, 3G, 4G, 5G, and the like. The mobile communication module 150 may include at least one filter, a switch, a power amplifier, a low noise amplifier (LNA), and the like. The mobile communication module 150 may receive an electromagnetic wave through the antenna 1, perform processing such as filtering and amplification on the received electromagnetic wave, and transfer a processed electromagnetic wave to the modem processor for demodulation. The mobile communication module 150 may further amplify a signal modulated by the modem processor, and convert the signal into an electromagnetic wave for radiation through the antenna 1. In some embodiments, at least some functional modules in the mobile communication module 150 may be disposed in the processor 110. In some embodiments, at least some functional modules in the mobile communication module 150 and at least some modules in the processor 110 may be disposed in a same device.

The modem processor may include a modulator and a demodulator. The modulator is configured to modulate a to-be-sent low frequency baseband signal into a medium and high frequency signal. The demodulator is configured to demodulate a received electromagnetic wave signal into a low frequency baseband signal. Then, the demodulator transmits the low frequency baseband signal obtained through demodulation to the baseband processor for processing. The baseband processor processes the low-frequency baseband signal, and then transfers a processed signal to the application processor. The application processor outputs a sound signal through an audio device (which is not limited to the speaker 170A, the receiver 170B, or the like), or displays an image or a video through the display screen 194. In some embodiments, the modem processor may be an independent device. In some other embodiments, the modem processor may be independent of the processor 110, and is disposed in the same device as the mobile communication module 150 or another functional module.

The wireless communication module 160 may provide a solution, applied to the terminal 1100, to wireless communication including a wireless local area network (WLAN) (for example, a wireless fidelity (Wi-Fi) network), Bluetooth (BT), a global navigation satellite system (GNSS), frequency modulation (FM), a near field communication (NFC) technology, an infrared (IR) technology, or the like. The wireless communication module 160 may be one or more components that integrate at least one communication processing module. The wireless communication module 160 receives an electromagnetic wave through the antenna 2, performs frequency modulation and filtering processing on the electromagnetic wave signal, and sends a processed signal to the processor 110. The wireless communication module 160 may further receive a to-be-sent signal from the processor 110, perform frequency modulation and amplification on the signal, and convert the signal into an electromagnetic wave for radiation through the antenna 2. For example, the wireless communication module 160 may include a Bluetooth module and a Wi-Fi module.

In some embodiments, in the terminal 1100, the antenna 1 is coupled to the mobile communication module 150, and the antenna 2 is coupled to the wireless communication module 160, so that the terminal 1100 can communicate with a network and another device by using a wireless communication technology. The wireless communication technology may include a global system for mobile communication (GSM), a general packet radio service (GPRS), code division multiple access (CDMA), wideband code division multiple access (WCDMA), time-division code division multiple access (TD-SCDMA), long term evolution (LTE), a BT, a GNSS, a WLAN, NFC, FM, an IR technology, and/or the like. The GNSS may include a global positioning system (GPS), a global navigation satellite system (GLONASS), a BeiDou navigation satellite system (BDS), a quasi-zenith satellite system (QZSS), and/or a satellite based augmentation system (SBAS).

The terminal 1100 may implement a display function by using the GPU, the display screen 194, the application processor, and the like. The GPU is a microprocessor for image processing, and is connected to the display screen 194 and the application processor. The GPU is configured to perform mathematical and geometric calculation, and render an image. The processor 110 may include one or more GPUs, and executes instructions to generate or change display information.

The display screen 194 is configured to display an image, a video, and the like. The display screen 194 includes a display panel. The display panel may be a liquid crystal display (LCD), an organic light-emitting diode (OLED), an active-matrix organic light-emitting diode (AMOLED), a flex light-emitting diode (FLED), a mini-LED, a micro-LED, a micro-OLED, quantum dot light-emitting diodes (QLED), or the like. In some embodiments, the terminal 1100 may include one or N displays 194, where N is a positive integer greater than 1. In the embodiments of this disclosure, the display screen 194 may be used as an output apparatus, configured to display response information of a user command, a GUI, or the like.

The terminal 1100 may implement a photographing function by using the ISP, the camera 193, the video codec, the GPU, the display screen 194, the application processor, and the like.

The ISP is configured to process data fed back by the camera 193. For example, during photographing, a shutter is pressed, light is transmitted to a photosensitive element of the camera through a lens, an optical signal is converted into an electrical signal, and the photosensitive element of the camera transmits the electrical signal to the ISP for processing, to convert the electrical signal into a visible image. The ISP may further perform algorithm optimization on noise, brightness, and complexion of the image. The ISP may further optimize parameters such as exposure and a color temperature of a photographing scenario. In some embodiments, the ISP may be disposed in the camera 193.

The camera 193 is configured to capture a static image or a video. An optical image of an object is generated through the lens, and is projected onto the photosensitive element. The photosensitive element may be a charge coupled device (CCD) or a complementary metal-oxide-semiconductor (CMOS) phototransistor. The photosensitive element converts an optical signal into an electrical signal, and then transmits the electrical signal to the ISP for converting the electrical signal into a digital image signal. The ISP outputs the digital image signal to the DSP for processing. The DSP converts the digital image signal into an image signal in a standard format such as RGB or YUV. In some embodiments, the terminal 1100 may include one or N cameras 193, where N is a positive integer greater than 1.

The digital signal processor is configured to process a digital signal, and may process another digital signal in addition to the digital image signal. For example, when the terminal 1100 selects a frequency, the digital signal processor is configured to perform Fourier transform and the like on frequency energy.

The video codec is configured to compress or decompress a digital video. The terminal 1100 may support one or more video codecs. In this way, the terminal 1100 can play or record videos in a plurality of encoding formats, for example, moving picture experts group (MPEG)-1, MPEG-2, MPEG-3, and MPEG-4.

The NPU is a neural network (NN) computing processor that rapidly processes input information with reference to a structure of a biological neural network, for example, with reference to a transfer mode between human brain neurons, and can further perform self-learning continuously. The NPU can implement applications such as intelligent cognition of the terminal 1100, such as image recognition, facial recognition, speech recognition, and text understanding.

The external memory interface 120 may be configured to connect to an external memory card, for example, a micro SD card, to extend a storage capability of the terminal 1100. The external storage card communicates with the processor 110 by using the external memory interface 120, to implement a data storage function. For example, data such as music, a photo, and video is stored in the external memory card.

The internal memory 121 may be configured to store one or more computer programs, and the one or more computer programs include instructions. The processor 110 may run the instructions stored in the internal memory 121, so that the terminal 1100 performs a data sharing method provided in some embodiments of this disclosure, various function applications, data processing, and the like. The internal memory 121 may include a program storage area and a data storage area. The program storage area may store an operating system. The program storage area may further store one or more applications (for example, “Gallery” and “Contacts”), and the like. The data storage area may store data (for example, a photo and a contact) created during use of the terminal 1100, and the like. In addition, the internal memory 121 may include a high-speed random access memory, and may further include a nonvolatile memory, for example, at least one magnetic disk storage device, a flash memory, and a universal flash storage (UFS).

The terminal 1100 may implement audio functions such as music playing and recording by using the audio module 170, the speaker 170A, the receiver 170B, the microphone 170C, the headset jack 170D, the application processor, and the like.

The audio module 170 is configured to convert digital audio information into an analog audio signal output, and is also configured to convert an analog audio input into a digital audio signal. The audio module 170 may be further configured to code and decode an audio signal. In some embodiments, the audio module 170 may be disposed in the processor 110, or some functional modules of the audio module 170 are disposed in the processor 110.

The speaker 170A, also referred to as a “horn”, is configured to convert an audio electrical signal into a sound signal. The terminal 1100 may be used to listen to music or answer a call in a hands-free mode over the speaker 170A. In the embodiments of this disclosure, the speaker 170A may be used as an output apparatus, configured to output the response information of the user command.

The receiver 170B, also referred to as an “earpiece”, is configured to convert an audio electrical signal into a sound signal. When a call is answered or a voice message is listened to by using the terminal 1100, the receiver 170B may be put close to a human ear to listen to voice.

The microphone 170C, also referred to as a “mike” or a “microphone”, is configured to convert a sound signal into an electrical signal. When making a call or sending voice information, a user may make a sound by moving a human mouth close to the microphone 170C to input a sound signal to the microphone 170C. At least one microphone 170C may be disposed in the terminal 1100. In some other embodiments, two microphones 170C may be disposed in the terminal 1100, to collect a sound signal and implement a noise reduction function. In some other embodiments, three, four, or more microphones 170C may alternatively be disposed in the terminal 1100, to collect a sound signal, implement noise reduction, and identify a sound source, so as to implement a directional recording function and the like. In some embodiments, the microphone 170C may be configured to acquire a user command in an audio format.

The headset jack 170D is configured to connect to a wired headset. The headset jack 170D may be a USB interface 130, or may be a 3.5 mm open mobile terminal platform (OMTP) standard interface or cellular telecommunication industry association of the USA (CTIA) standard interface.

The pressure sensor 180A is configured to sense a pressure signal, and can convert the pressure signal into an electrical signal. In some embodiments, the pressure sensor 180A may be disposed on the display screen 194. There are a plurality of types of pressure sensors 180A, such as a resistive pressure sensor, an inductive pressure sensor, and a capacitive pressure sensor. The capacitive pressure sensor may include at least two parallel plates made of conductive materials. When force is applied to the pressure sensor 180A, capacitance between electrodes changes. The terminal 1100 determines pressure intensity based on a capacitance change. When a touch operation is performed on the display screen 194, the terminal 1100 detects intensity of the touch operation by using the pressure sensor 180A. The terminal 1100 may also calculate a touch position based on a detection signal of the pressure sensor 180A. In some embodiments, touch operations that are performed at a same touch location but have different touch operation intensity may correspond to different operation instructions. For example, when a touch operation whose touch operation intensity is less than a first pressure threshold is performed on an application icon “Messages”, an instruction for viewing an SMS message is executed. When a touch operation whose touch operation intensity is greater than or equal to the first pressure threshold is performed on an application icon “Messages”, an instruction for creating an SMS message is executed.

The gyro sensor 180B may be configured to determine a motion posture of the terminal 1100. In some embodiments, an angular velocity of the terminal 1100 around three axes (namely, x, y, and z axes) may be determined by using the gyro sensor 180B. The gyroscope sensor 180B may be configured to implement image stabilization during photographing. For example, when a shutter is pressed, the gyro sensor 180B detects a shaking angle of the terminal 1100, calculates, based on the angle, a distance that a lens module needs to compensate, and allows the lens to cancel shaking of the terminal 1100 through reverse motion, to implement image stabilization. The gyroscope sensor 180B may be further used in a navigation scenario and a motion-sensing game scenario.

The barometric pressure sensor 180C is configured to measure barometric pressure. In some embodiments, the terminal 1100 calculates an altitude by using a barometric pressure value obtained through measurement by the barometric pressure sensor 180C, to assist in positioning and navigation.

The magnetic sensor 180D includes a Hall effect sensor. The terminal 1100 may detect opening and closing of a flip carrying case by using the magnetic sensor 180D. In some embodiments, when the terminal 1100 is a flip phone, the terminal 1100 may detect opening and closing of a flip cover by using the magnetic sensor 180D. Further, a feature such as automatic unlocking upon opening of the flip cover is set based on a detected opening or closing state of the leather case or a detected opening or closing state of the flip cover.

The acceleration sensor 180E may detect magnitude of accelerations in various directions (usually on three axes) of the terminal 1100. When the terminal 1100 is still, a value and a direction of gravity may be detected. The acceleration sensor 180E may be further configured to recognize a posture of the electronic device, and is used in screen switching between a landscape mode and a portrait mode, a pedometer, or another application.

The distance sensor 180F is configured to measure a distance. The terminal 1100 may measure a distance through infrared light or a laser. In some embodiments, in a photographing scenario, the terminal 1100 may measure a distance by using the distance sensor 180F, to implement fast focusing.

The optical proximity sensor 180G may include, for example, a light-emitting diode (LED) and an optical detector such as a photodiode. The light-emitting diode may be an infrared light-emitting diode. The terminal 1100 emits infrared light by using the light-emitting diode. The terminal 1100 uses the photodiode to detect reflected infrared light from a nearby object. When sufficient reflected light is detected, it may be determined that there is an object near the terminal 1100. When insufficient reflected light is detected, the terminal 1100 may determine that there is no object near the terminal 1100. The terminal 1100 may detect, by using the optical proximity sensor 180G, that the user holds the terminal 1100 close to an ear to make or answer a call, and therefore automatically turn off the screen to save power. The optical proximity sensor 180G may also be used in a leather case mode or a pocket mode to automatically unlock or lock the screen.

The ambient light sensor 180L is configured to sense ambient light brightness. The terminal 1100 may adaptively adjust brightness of the display screen 194 based on the sensed ambient light intensity. The ambient light sensor 180L may also be configured to automatically adjust a white balance during photographing. The ambient light sensor 180L may further cooperate with the optical proximity sensor 180G in detecting whether the terminal 1100 is in a pocket, to prevent an accidental touch.

The fingerprint sensor 180H is configured to collect a fingerprint. The terminal 1100 may use a feature of the collected fingerprint to implement fingerprint-based unlocking, application lock access, fingerprint-based photographing, fingerprint-based call answering, and the like.

The temperature sensor 180J is configured to detect a temperature. In some embodiments, the terminal 1100 executes a temperature processing policy based on a temperature detected by the temperature sensor 180J. For example, when a temperature reported by the temperature sensor 180J exceeds a threshold, the terminal 1100 lowers performance of a processor close to the temperature sensor 180J, to reduce power consumption and implement thermal protection. In some other embodiments, when a temperature is less than another threshold, the terminal 1100 heats the battery 142 to prevent abnormal shutdown of the terminal 1100 caused by the low temperature. In some other embodiments, when a temperature is less than still another threshold, the terminal 1100 boosts an output voltage of the battery 142 to prevent abnormal shutdown caused by the low temperature.

The touch sensor 180K may also be referred to as a touch panel or a touch-sensitive surface. The touch sensor 180K may be disposed on the display screen 194, and the touch sensor 180K and the display screen 194 form a touchscreen, which is also referred to as a “touch screen”. The touch sensor 180K is configured to detect a touch operation performed on or near the touch sensor 180K. The touch sensor may transfer the detected touch operation to the application processor, to determine a type of a touch event. Visual output related to the touch operation may be provided on the display screen 194. In some other embodiments, the touch sensor 180K may be alternatively disposed on a surface of the terminal 1100, in a position different from that of the display screen 194. In some embodiments, the touch sensor 180K may be used as an input apparatus, configured to receive a user command in a text format entered by a user, or another user operation.

The bone conduction sensor 180M may obtain a vibration signal. In some embodiments, the bone conduction sensor 180M may obtain a vibration signal of a vibration bone of a human vocal-cord part. The bone conduction sensor 180M may also be in contact with a human pulse, to receive a blood pressure beating signal. In some embodiments, the bone conduction sensor 180M may alternatively be disposed in a headset to form a bone conduction headset. The audio module 170 may obtain a voice signal through parsing based on the vibration signal that is of the vibration bone of the vocal-cord part and that is obtained by the bone conduction sensor 180M, to implement a voice function. The application processor may parse heart rate information based on the blood pressure beating signal obtained by the bone conduction sensor 180M, to implement a heart rate detection function.

The button 190 includes a power button, a volume button, and the like. The button 190 may be a mechanical button, or may be a touch button. The terminal 1100 may receive a button input, and generate a button signal input related to user setting and function control of the terminal 1100.

The motor 191 may generate a vibration prompt. The motor 191 may be configured to provide an incoming call vibration prompt and a touch vibration feedback. For example, touch operations performed on different applications (for example, photographing and audio playing) may correspond to different vibration feedback effects. The motor 191 may also correspond to different vibration feedback effects for touch operations performed on different areas of the display screen 194. Different application scenarios (for example, a time reminder, information receiving, an alarm clock, and a game) may also correspond to different vibration feedback effects. A touch vibration feedback effect may be further customized.

The indicator 192 may be an indicator light, and may be configured to indicate a charging status and a power change, or may be configured to indicate a message, a missed call, a notification, and the like.

The SIM card interface 195 is configured to connect to a SIM card. The SIM card may be inserted into the SIM card interface 195 or detached from the SIM card interface 195, to implement contact with or separation from the terminal 1100. The terminal 1100 may support one or N SIM card interfaces, where N is a positive integer greater than 1. The SIM card interface 195 can support a nano-SIM card, a micro-SIM card, a SIM card, and the like. A plurality of cards may be simultaneously inserted into a same SIM card interface 195. The plurality of cards may be of a same type or of different types. The SIM card interface 195 may be compatible with different types of SIM cards. The SIM card interface 195 may also be compatible with an external storage card. The terminal 1100 interacts with a network by using the SIM card, to implement functions such as conversation and data communication. In some embodiments, the terminal 1100 uses an eSIM, namely, an embedded SIM card. The eSIM card may be embedded into the terminal 1100, and cannot be separated from the terminal 1100.

For example, the terminal 1100 shown in FIG. 11 may display, by using the display screen 194, user interfaces described in the following embodiments. The terminal 1100 may detect a touch operation in each user interface by using the touch sensor 180K, for example, a tap operation (for example, a touch operation or a double-tap operation on an icon) in each user interface, or an upward or downward slide operation or an operation of drawing a circle gesture in each user interface. In some embodiments, the terminal 1100 may detect, by using the gyroscope sensor 180B, the acceleration sensor 180E, or the like, a motion gesture performed by a user by holding the terminal 1100, for example, shaking an electronic device. In some embodiments, the terminal 1100 may detect a non-touch gesture operation by using the camera 193 (for example, a 3D camera or a depth camera).

In this embodiment of this disclosure, the terminal 1100 may implement the method or steps performed by the terminal in any one of Embodiment 1 to Embodiment 5. For details, refer to related descriptions in Embodiment 1 to Embodiment 5. Details are not described herein again.

The following describes an example server 1200 according to an embodiment of this disclosure. The server 1200 may be implemented as the business server mentioned in any one of Embodiment 1 to Embodiment 5, may be the server configured to interact with the terminal of the GUI shown in FIG. 1A to FIG. 1E, or may be the first server or the third server in the scenario shown in FIG. 2A and FIG. 2B, or may be the business server 32 in the system 30 shown in FIG. 3. In some embodiments, the server 1200 may also implement the method or steps implemented by the speech recognition server and/or the natural language understanding server.

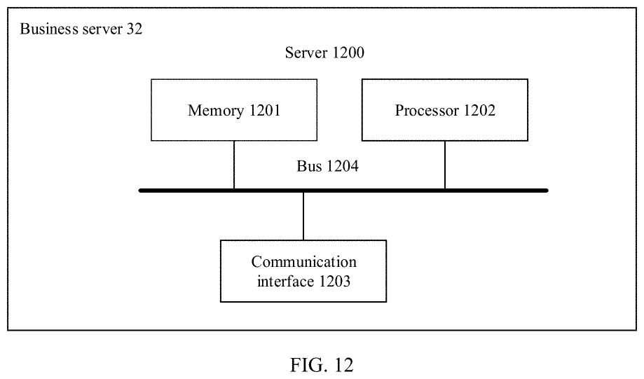

FIG. 12 is a schematic diagram of a hardware structure of a server according to an embodiment of the present disclosure. The server 1200 shown in FIG. 12 includes a memory 1201, a processor 1202, a communication interface 1203, and a bus 1204. Communication connections between the memory 1201, the processor 1202, and the communication interface 1203 are implemented through the bus 1204.

The memory 1201 may be a read-only memory (ROM), a static storage device, a dynamic storage device, or a random access memory (RAM). The memory 1201 may store programs. When the programs stored in the memory 1201 are executed by the processor 1202, the processor 1202 and the communication interface 1203 are configured to perform the method or steps performed by the business server in any one of Method Embodiments 1 to 5 in this disclosure.

The processor 1202 may be a general-purpose central processing unit (CPU), a microprocessor, an application-specific integrated circuit (ASIC), a graphics processing unit (GPU), or one or more integrated circuits, configured to execute related programs, to implement functions to be executed by the units in the command execution apparatus 900 in the embodiments of this disclosure, or perform the method or steps executed by the business server in any one of Method Embodiments 1 to 5 in this disclosure.

The processor 1202 may alternatively be an integrated circuit chip and has a signal processing capability. In an implementation process, the steps of the command exectution method in this application may be completed by using a hardware integrated logic circuit in the processor 1202 or an instruction in a form of software. The processor 1202 may alternatively be a general-purpose processor, a digital signal processor (DSP), an application-specific integrated circuit (ASIC), a field programmable gate array (FPGA) or another programmable logic device, a discrete gate or transistor logic device, or a discrete hardware component. The methods, the steps, and logic block diagrams that are disclosed in the embodiments of this disclosure may be implemented or performed. The general purpose processor may be a microprocessor, or the processor may be any conventional processor or the like. Steps of the methods disclosed with reference to the embodiments of this disclosure may be directly executed and accomplished by using a hardware decoding processor, or may be executed and accomplished by using a combination of hardware and software modules in a decoding processor. The software module may be located in a mature storage medium in the art, such as a random access memory, a flash memory, a read-only memory, a programmable read-only memory, an electrically erasable programmable memory, or a register. The storage medium is located in the memory 1201. The processor 1202 reads information in the memory 1201, and completes, in combination with hardware of the processor 1202, functions that need to be performed by units in the command execution apparatus 900 in the embodiments of this disclosure, or performs the method or steps performed by the business server in any one of Method Embodiments 1 to 5 in this disclosure.

The communication interface 1203 uses a transceiver apparatus, for example, but not limited to, a transceiver, to implement communication between the server 1200 and another device or a communication network. For example, data from the terminal, for example, a first request, a first GUI information set, filling information of a first slot, GUI information corresponding to the first slot, and a second GUI information set may be received by using the communication interface 1203.

The bus 1204 may include a path for information transfer between various components (for example, the memory 1201, the processor 1202, and the communication interface 1203) of the server 1200.

In this embodiment of this disclosure, the server 1200 may implement the method or steps performed by a server such as the business server, the speech recognition server, and/or the natural language understanding server in any one of Embodiments 1 to 5. For details, refer to related descriptions in Embodiments 1 to 5. Details are not described herein again.

It should be noted that although only the memory, the processor, and the communication interface are shown in the server 1200 shown in FIG. 12, in a specific implementation process, a person skilled in the art should understand that the server 1200 further includes other components necessary for implementing a normal operation. In addition, based on a specific requirement, a person skilled in the art should understand that the server 1200 may further include hardware components for implementing other additional functions. In addition, a person skilled in the art should understand that the server 1200 may alternatively include only devices required for implementing the embodiments of this disclosure, but does not necessarily include all the devices shown in FIG. 12.

A person of ordinary skill in the art may be aware that, in combination with the examples described in the embodiments disclosed in this specification, units and algorithm steps may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of this disclosure.

A person skilled in the art can appreciate that functions described in connection with various illustrative logical blocks, modules, and algorithm steps disclosed and described herein may be implemented by hardware, software, firmware, or any combination thereof. If implemented by software, the functions described by various illustrative logical blocks, modules, and steps may be stored or transmitted as one or more instructions or code on a computer-readable medium and executed by a hardware-based processing unit. The computer-readable medium may include a computer-readable storage medium corresponding to a tangible medium, such as a data storage medium, or any communication medium that facilitates transmission of a computer program from one place to another (for example, according to a communication protocol). In this manner, the computer-readable medium may be generally corresponding to: (1) a non-transitory tangible computer-readable storage medium, or (2) a communication medium such as a signal or a carrier. The data storage medium may be any available medium that can be accessed by one or more computers or one or more processors to retrieve instructions, code, and/or data structures for implementing the technologies described in this disclosure. A computer program product may include a computer-readable medium.

By way of example and not limitation, some computer-readable storage media may include a RAM, a ROM, an EEPROM, a CD-ROM or another optical disc storage apparatus, a magnetic disk storage apparatus or another magnetic storage apparatus, a flash memory, or any other medium that can store required program code in a form of an instruction or a data structure and can be accessed by a computer. In addition, any connection is appropriately referred to as a computer-readable medium. For example, if an instruction is sent from a website, a server, or another remote source by using a coaxial cable, an optical cable, a twisted pair, a digital subscriber line (DSL), or a wireless technology such as infrared, radio, and microwave, the coaxial cable, the optical cable, the twisted pair, the DSL, or the wireless technology such as infrared, radio, and microwave is included in a definition of a medium. However, it should be understood that the computer-readable storage medium and the data storage medium may not include a connection, a carrier, a signal, or another transitory medium, but actually mean non-transitory tangible storage media. A disk and an optical disc used in this specification include a compact disc (CD), a laser disc, an optical disc, a digital versatile disc (DVD), and a Blu-ray disc, where the disk generally magnetically reproduces data, and the optical disc optically reproduces data by using a laser. A combination of the foregoing objects shall further be included in the scope of the computer-readable medium.

Instructions may be executed by one or more processors such as one or more digital signal processors (DSP), a general microprocessor, an application-specific integrated circuit (ASIC), a field programmable gate array (FPGA), or an equivalent integrated or discrete logic circuit. Therefore, the term “processor” used in this specification may refer to the foregoing structure, or any other structure that may be applied to implementation of the technologies described in this specification. Moreover, in some aspects, the functions described in the various illustrative logical blocks, modules, and steps described herein may be provided within dedicated hardware and/or software modules configured to perform encoding and decoding, or incorporated into a combined codec. In addition, the technologies may be completely implemented in one or more circuits or logic elements.

The technologies of this disclosure may be implemented in various apparatuses or devices, including wireless handheld phones, integrated circuits (ICs), or a set of ICs (for example, chipsets). Various components, modules, or units are described in this disclosure to emphasize functional aspects of the apparatus for performing the disclosed technologies, but are not necessarily implemented by different hardware units. Actually, as described above, various units may be combined in a codec hardware unit in combination with appropriate software and/or firmware, or provided by an interoperable hardware unit (including one or more processors as described above).

The terms used in the following embodiments are merely intended to describe specific embodiments, but are not intended to limit this disclosure. The terms “one”, “a”, “the”, “the foregoing”, “this”, and “the one” of singular forms used in this specification and the appended claims of this disclosure are also intended to include plural forms such as “one or more”, unless otherwise specified in the context clearly. It should be further understood that, in the following embodiments of this disclosure, “at least one” or “one or more” means one, two, or more. The term “and/or” is used to describe an association relationship between associated objects, and represents that three relationships may exist. For example, A and/or B may represent the following cases: Only A exists, both A and B exist, and only B exists. A and B may be singular or plural. The character “/” usually indicates an “or” relationship between the associated objects.

Reference to “an embodiment”, “some embodiments”, or the like described in this specification indicates that one or more embodiments of this disclosure include a specific feature, structure, or characteristic described with reference to the embodiments. Therefore, in this specification, statements, such as “in an embodiment”, “in some embodiments”, “in some other embodiments”, and “in other embodiments”, that appear at different places do not necessarily mean referring to a same embodiment, instead, they mean “one or more but not all of the embodiments”, unless otherwise specifically emphasized in other ways. The terms “include”, “comprise”, “have”, and variants of the terms all mean “include but are not limited to”, unless otherwise specifically emphasized in other ways.

The foregoing descriptions are merely examples of specific implementations of this disclosure, but are not intended to limit the protection scope of this disclosure. Any variation or replacement readily figured out by a person skilled in the art within the technical scope disclosed in this disclosure shall fall within the protection scope of this disclosure. Therefore, the protection scope of this disclosure shall be subject to the protection scope of the claims.

What is claimed is:

1. A command execution method applied to a terminal, comprising:
generating a first request based on an input user command, wherein the first request is used to request a server to execute the user command;
sending the first request to the server;
receiving a second request sent by the server, wherein the second request is used to request first information from the terminal, and the first information is used to determine filling information of a first slot;
determining the first information in a first graphic user interface (GUI) information set based on the second request; and
sending the first information to the server, wherein the first slot is a slot that lacks filling information among the M slots configured for a target intent of the user command, M is a positive integer, the first GUI information set comprises a correspondence between slots and GUI information, and the target intent and filling information of the M slots are used to execute the input user command.

2. The method according to claim 1, wherein the method further comprises: updating or storing GUI information corresponding to a first control when a user operation for the first control is detected on a GUI, wherein the GUI is a user interface displayed on the terminal.

3. The method according to claim 1, wherein the first information is the filling information of the first slot or GUI information corresponding to the first slot.

4. The method according to claim 1, wherein the generating a first request based on an input user command comprises:
identifying a predicted intent of the input user command;
obtaining GUI information corresponding to a second slot from the first GUI information set when filling information of the second slot is missing, wherein the second slot is a slot that lacks filling information among the N slots configured for the predicted intent of the input user command, and N is a positive integer; and
generating the first request based on the input user command and the GUI information corresponding to the second slot, wherein the first request carries the GUI information corresponding to the second slot, so that after receiving the first request, the server determines the first slot based on the input user command and the GUI information corresponding to the second slot.

5. The method according to claim 1, wherein the generating a first request based on an input user command comprises:
generating the first request based on the input user command and a second GUI information set, wherein the first request carries the second GUI information set, so that after receiving the first request, the server determines the first slot based on the user command and the second GUI information set.

6. A command execution method applied to a server, comprising:
receiving a first request sent by a terminal, wherein the first request is used to request the server to execute a user command;
determining filling information of a first slot from a first GUI information set when the filling information of the first slot is missing, wherein the first slot is a slot that lacks filling information among the M slots configured for a target intent of the user command, M is a positive integer, and the first GUI information set comprises a correspondence between slots and GUI information; and
executing the user command based on the target intent of the user command and filling information of the slots configured for the target intent.

7. The method according to claim 6, wherein the first GUI information set comprises GUI information corresponding to a first control, the GUI information corresponding to the first control is stored or updated by the terminal when the terminal detects a user operation for the first control on a GUI, wherein the GUI is a user interface displayed on the terminal.

8. The method according to claim 7, wherein the determining filling information of a first slot from a first GUI information set when the filling information of the first slot is missing comprises:
sending a second request to the terminal when the filling information of the first slot is missing, wherein the second request is used to request the filling information of the first slot from the terminal; and
receiving the filling information of the first slot from the terminal, wherein the filling information of the first slot is determined by the terminal from the first GUI information set.

9. The method according to claim 7, wherein the determining filling information of a first slot from a first GUI information set when the filling information of the first slot is missing comprises:
sending a third request to the terminal when the filling information of the first slot is missing, wherein the third request is used to request GUI information corresponding to the first slot from the terminal;
receiving the GUI information corresponding to the first slot from the terminal, wherein the GUI information corresponding to the first slot is determined by the terminal from the first GUI information set; and
determining the filling information of the first slot based on the GUI information corresponding to the first slot.

10. The method according to claim 6, wherein the first request carries GUI information corresponding to a second slot, and after the receiving a first request sent by a terminal and before the determining filling information of a first slot from a first GUI information set when the filling information of the first slot is missing, the method further comprises:
determining the first slot based on the user command and the GUI information corresponding to the second slot, wherein the second slot is a slot that lacks filling information among the N slots configured for a predicted intent of the user command, N is a positive integer, and the predicted intent is an intent of the user command identified by the terminal.

11. The method according to claim 6, wherein the first request carries a second GUI information set, and after the receiving a first request sent by a terminal and before the determining filling information of a first slot from a first GUI information set when the filling information of the first slot is missing, the method further comprises:
determining the first slot based on the user command and the second GUI information set.

12. The method according to claim 6, wherein the first request carries the first GUI information set.

13. The method according to claim 7, wherein the method further comprises:
receiving the GUI information corresponding to the first control from the terminal, and updating or storing the GUI information corresponding to the first control, wherein the first control is a control on the GUI on the terminal.

14. A terminal, wherein the terminal comprises one or more processors, one or more memories, and a communication interface, wherein the communication interface is configured to perform data exchange with a server, the one or more memories are coupled to the one or more processors, the one or more memories are configured to store a computer program, the computer program comprises computer instructions, and when the one or more processors execute the computer instructions, the terminal performs:
generating a first request based on an input user command, wherein the first request is used to request a server to execute the input user command;
sending the first request to the server;
receiving a second request sent by the server, wherein the second request is used to request first information from the terminal, and the first information is used to determine filling information of a first slot;
determining the first information in a first GUI information set based on the second request; and
sending the first information to the server, wherein the first slot is a slot that lacks filling information among the M slots configured for a target intent of the user command, M is a positive integer, the first GUI information set comprises a correspondence between slots and GUI information, and the target intent and filling information of the M slots are used to execute the user command.

15. The terminal according to claim 14, wherein the terminal further performs:
updating or storing GUI information corresponding to a first control when a user operation for the first control is detected on a GUI, wherein the GUI is a user interface displayed on the terminal.

16. The terminal according to claim 14, wherein the first information is the filling information of the first slot or GUI information corresponding to the first slot.

17. The terminal according to claim 14, wherein the generating a first request based on an input user command comprises:
identifying a predicted intent of the input user command;
obtaining GUI information corresponding to a second slot from the first GUI information set when filling information of the second slot is missing, wherein the second slot is a slot that lacks filling information among the N slots configured for the predicted intent of the user command, and N is a positive integer; and
generating the first request based on the user command and the GUI information corresponding to the second slot, wherein the first request carries the GUI information corresponding to the second slot, so that after receiving the first request, the server determines the first slot based on the user command and the GUI information corresponding to the second slot.

18. The terminal according to claim 14, wherein the generating a first request based on an input user command comprises:
generating the first request based on the input user command and a second GUI information set, wherein the first request carries the second GUI information set, so that after receiving the first request, the server determines the first slot based on the user command and the second GUI information set.
